(19) United States
(12) Patent Application Publication
(10) Pub. No.: US 2019/0352101 A1
(43) Pub. Date: Nov. 21, 2019

(54) SYSTEMS, APPARATUSES, AND METHODS FOR LOADING CONTAINERS ONTO PALLETS AND DOLLIES

(71) Applicant: Cannon Equipment LLC, Cannon Falls, MN (US)

(72) Inventors: Douglas Levine, Inver Grove Heights, MN (US); Mark Ronald Rosa, Rosemount, MN (US); Gregory Lawrence Nordling, Lakeville, MN (US); Phillip E. Levine, Inver Grove Heights, MN (US); Sagar D. Bhogle, Saint Paul, MN (US)

(73) Assignee: Cannon Equipment LLC, Cannon Falls, MN (US)

(21) Appl. No.: 16/408,733

(22) Filed: May 10, 2019

Related U.S. Application Data
(60) Provisional application No. 62/671,672, filed on May 15, 2018.

(51) Int. Cl. B65G 47/14; B65G 47/24; B65D 19/38; B65D 19/42

(52) U.S. Cl. CPC B65G 47/1442; B65D 19/42; B65D 19/385; B65G 47/24

(57) ABSTRACT

A system for loading containers onto a transport structure includes a slip sheet configured to receive the containers. The slip sheet is moveable from a first position in which the containers are received onto the slip sheet and a second position in which the slip sheet is vertically above the transport structure. A first brace member is adjacent to the second end of the slip sheet and a second brace member is adjacent to the first end of the slip sheet when the slip sheet is in the second position such that when the slip sheet is moved in a second direction from the second position to the first position the second brace member is configured to prevent the containers from moving in the second direction with the slip sheet and the containers vertically fall off the slip sheet onto the transport structure.

### CROSS-REFERENCE TO RELATED APPLICATION

The present application is based on and claims priority to U.S. Provisional Patent Application No. 62/671,672 filed May 15, 2018, the disclosure of which is incorporated herein by reference.

### FIELD

The present disclosure relates to systems, apparatuses, and methods for loading containers onto pallets and dollies.

### BACKGROUND

The following U.S. patent is incorporated herein by reference in entirety.

U.S. Pat. No. 9,873,172 discloses an automated pallet checker system for checking the structural integrity of a pallet. The system includes a conveyor arrangement mounted on a framework and operable to convey the pallet to be checked through an in-feed station and a lift station connected to the in-feed station. The in-feed station is configured to check the pallet for a presence or absence of pallet bottom cross boards as the pallet is carried on the conveyor arrangement. The lift station is also configured to check for obstructions depending from the pallet bottom cross boards, and missing material in leading and trailing edges of the pallet top cross boards during a lifting movement of the pallet in the lift station.

### SUMMARY

This Summary is provided to introduce a selection of concepts that are further described below in the Detailed Description. This Summary is not intended to identify key or essential features of the claimed subject matter, nor is it intended to be used as an aid in limiting the scope of the claimed subject matter.

In certain examples, a system for loading containers onto a transport structure includes a slip sheet configured to receive the containers and having a first end and an opposite second end. The slip sheet is moveable in a first direction from a first position in which the containers are received onto the slip sheet and a second position in which the slip sheet is vertically above the transport structure, and the slip sheet is further movable in a second direction opposite the first direction to thereby move the slip sheet from the second position to the first position. A first brace member is adjacent to the second end of the slip sheet when the slip sheet is in the second position, and a second brace member is adjacent to the first end of the slip sheet when the slip sheet is in the second position wherein when the slip sheet is moved in the second direction from the second position to the first position the second brace member is configured to prevent the containers from moving in the second direction with the slip sheet such that the containers vertically fall off the slip sheet onto the transport structure. The first brace member is configured to vertically guide the containers onto the transport structure.

In certain examples, a method of loading containers onto a transport structure includes receiving containers onto a slip sheet having a first end and an opposite second end and moving the slip sheet with the containers thereon in a first direction from a first position in which the containers are loaded onto the slip sheet to a second position in which the slip sheet is vertically above the transport structure. A first brace member is adjacent to the second end of the slip sheet when the slip sheet is in the second position. The method can further include moving a second brace member adjacent to the first end of the slip sheet when the slip sheet is in the second position and moving the slip sheet in a second direction opposite the first direction from the second position to the first position such that the second brace member prevents the containers from being moved with the slip sheet in the second direction and the containers fall off the slip sheet onto the transport structure. The first brace member can vertically guide the containers onto the transport structure.

Various other features, objects, and advantages will be made apparent from the following description taken together with the drawings.

### BRIEF DESCRIPTION OF THE DRAWINGS

The present disclosure is described with reference to the following Figures. The same numbers are used throughout the Figures to reference like features and like components.

FIG. 1 is a perspective view of an example system according to the present disclosure.

FIG. 2 is a perspective view of an example dolly dispenser.

FIG. 3 is a top-down plan view of the dolly dispenser of FIG. 2.

FIGS. 4A-4F are side and end views of an example operational sequence of the dolly dispenser.

FIG. 5 is a perspective view of an example pallet dispenser.

FIGS. 6A-6B are cross-sectional views of the pallet dispenser of FIG. 5 along line F-F on FIG. 5.

FIG. 7 is a perspective view of an example loading system.

FIG. 8 is a top-down plan view of the loading system of FIG. 7.

FIGS. 9A-9D are top-down plan views of an example operational sequence of the loading system for organizing containers on a slip sheet.

FIGS. 10A-10F are side views of an example operational sequence of the loading system for loading the containers onto a pallet and a tray.

FIG. 11 is a bottom perspective view of an example lift apparatus.

FIG. 12A is a top perspective view of the lift apparatus of FIG. 11. The lift apparatus has forks that are positioned to receive a pallet.

FIG. 12B is a top perspective view of the lift apparatus of FIG. 11. The forks are positioned to receive a dolly.

FIGS. 13A-13H are end views of an example operational sequence of the lift apparatus moving the pallet such that layers of containers are loaded onto the pallet.

FIG. 14 is an end view of an example gantry arm machine for lifting and placing trays onto the containers and the pallet.

FIGS. 15A-15E are side views of an example operational sequence of the gantry arm machine for lifting trays from a stack of trays.

FIGS. 16-27 are side and end views of an example operational sequence of the gantry arm machine for moving and placing the trays onto the pallet.

FIGS. 28-29 are perspective views of another example lifting assembly.

FIG. 30 is a perspective view of an example packaging section.

FIG. 31 is a perspective view of an example lift device with a pallet loaded with containers adjacent thereto.

FIGS. 32A-32C are schematic views of an example operational sequence of the lift device shown in FIG. 31.

FIG. 33 is a perspective view of an example conveyor.

FIG. 34 is a perspective view of a pallet on the conveyor shown in FIG. 33.

FIG. 35 is a perspective view of a dolly on the conveyor shown in FIG. 33.

FIG. 36 is another perspective view of the pallet on the conveyor shown in FIG. 33.

FIG. 37 is another perspective view of a dolly on the conveyor shown in FIG. 33.

FIG. 38 is a perspective view of an example lift device and an example dolly pusher.

FIGS. 39-43 are side views of an example operational sequence of the dolly pusher for pushing the dolly loaded with containers off the conveyor.

FIG. 44 is a perspective view of an example lift device and an example ejector.

FIGS. 45-47 are perspective and side views of the ejector in different operational positions.

FIG. 48 is a perspective view of an example tray dispenser.

### DETAILED DESCRIPTION

The present inventors have recognized that floor space in facilities that bottle liquid products, such as milk, into containers is limited. As such, there is a need to maximize the usefulness of the floor space to increase the efficiency and effectiveness of the facility. The present inventors have also recognized that containers can be organized, loaded, and stacked onto different types of transport structures, such as wooden pallets, plastic pallets, or plastic dollies. Different types of transport structures often require separate and distinct machines to load containers onto each type of transport structure. A pallet loading machine is often used to load containers, such as gallon milk jugs, onto conventional wooden pallets. A dolly loading machine is often used to load containers onto dollies. These machines occupy large amounts of floor space within the facility.

The present inventors have found it desirable to install a single machine or system capable of organizing, loading, and stacking containers, such as gallon milk jugs, onto different types of transport structures. Utilizing a single system reduces the amount of floor space in the facility needed to load containers onto the different types of support structures. As such, the present inventors have designed and developed the loading systems of the present disclosure, which are capable of organizing, loading, and stacking containers onto different types of transport structures, such as pallets and dollies.

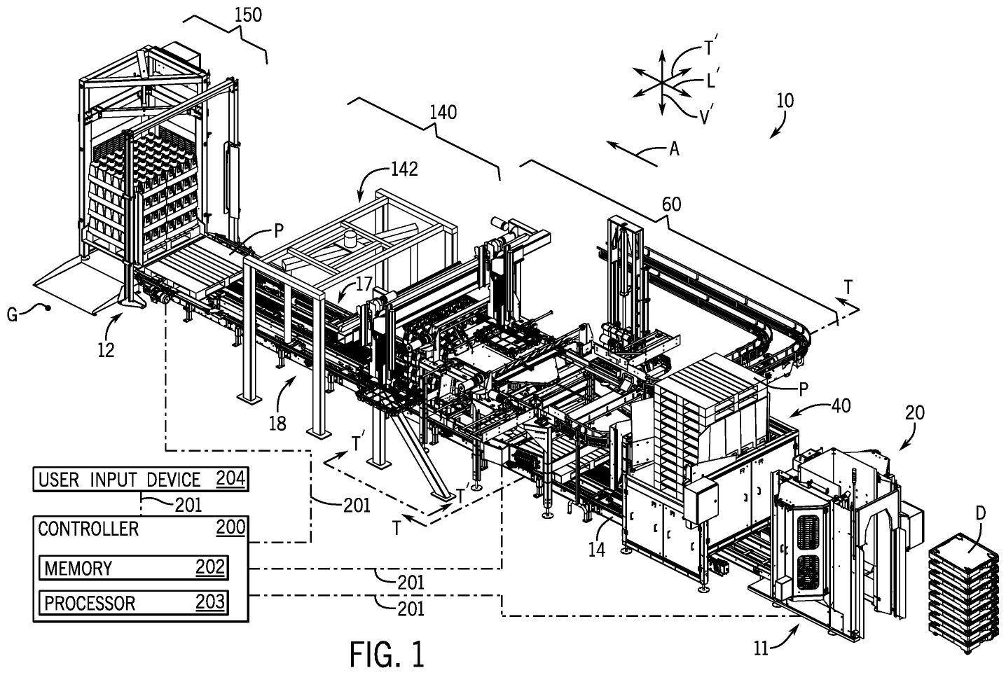

FIG. 1 depicts an example system 10 according to the present disclosure. The system 10 has an upstream end 11, an opposite downstream end 12, and a conveyor 14 extending between the ends 11, 12. The system 10 includes various sections and systems positioned along the conveyor 14 for receiving, processing, and dispensing containers C onto pallets P or dollies D. In general, the dollies D and the pallets P are conveyed through the system 10 in a first direction (arrow A). The longitudinal direction (arrow L′), the lateral direction (arrow T′), and the vertical direction (arrow V′) relative to the system 10 are depicted in FIG. 1

The system 10 includes a dolly dispenser 20 that dispenses dollies D onto the conveyor 14 and a pallet dispenser 40 that dispenses pallets P onto the conveyor 14. A container loading system 60 is downstream from the pallet and dolly dispensers 20, 40 and is for receiving containers C, organizing the containers C into layers of containers C, and loading the layers of containers C onto a pallet P or a dolly D. After the pallet P or dolly D is loaded with containers C, the loaded pallet P or dolly D is conveyed downstream by the conveyor 14 to a packaging section 140 in which the loaded pallet P or dolly D is packaged and/or further processed. The conveyor 14 further conveys the loaded pallet P or dolly D to a lift device 150 that transfers the loaded pallet P or dolly D from the conveyor 14 to another machine (not shown) or onto the ground G. The loaded pallet P or dolly D can then be moved away from the system 10 (manually or with a forklift) and shipped to its retail destination on trucks and other vehicles.

The system 10 is equipped with a controller 200 for the controlling and operating the various sections of the system 10, including the components or devices included at each section, as will be further described hereinbelow. The controller 200 has a memory 202 and a processor 203. The controller 200 is connected to the various sections and/or components thereof via wired or wireless communication links 201. The controller 200 is located on any of the sections of the system 10. In other examples, the controller 200 may be remotely located and/or integrated with an existing automation system (not shown). A user input device 204 is in communication with the controller 200 and is for receiving inputs from an operator pertaining to the operation, programming, and/or maintenance of the system 10. Programs and/or software stored on the memory 202 are executed by the processor 203 and/or controller 200 to thereby operate the systems described hereinbelow. As will become apparent from the disclosure hereinbelow, the controller 200 is capable of monitoring and controlling operational characteristics of the system 10 by sending and/or receiving control signals via the communication links 201. In certain examples, the controller 200 is in communication with various sensors that provide feedback signals to the controller 200 such that the controller 200 efficiently, effectively, and safely controls operation of the system 10.

The components and operation of the dispensers 20, 40, the conveyor 14, the loading system 60, the packaging section 140, and the lift device 150 are described in greater detail hereinbelow.

Dolly Dispenser

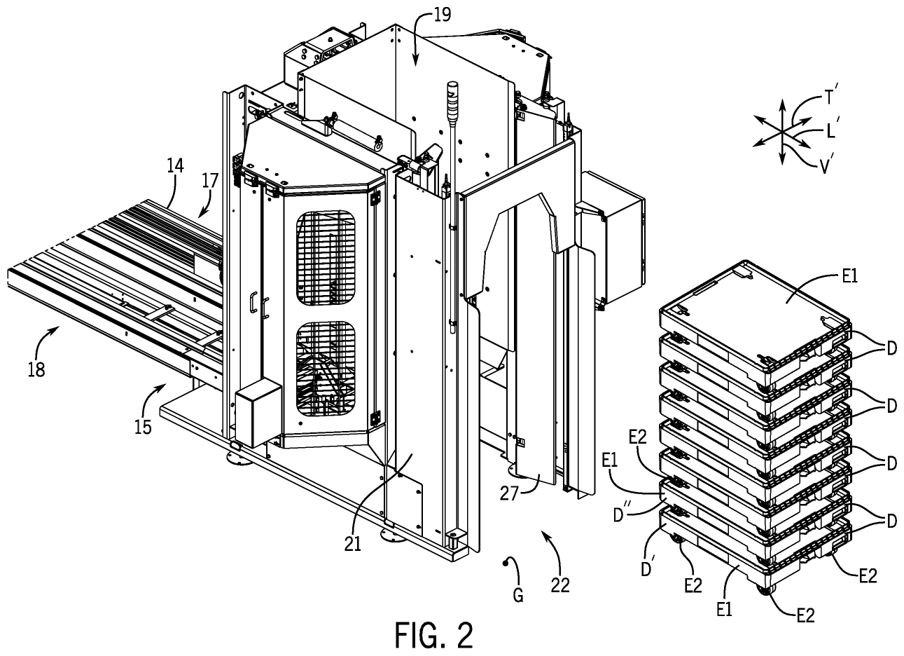

Referring to FIG. 2, the dolly dispenser 20 is at the upstream end 15 of the conveyor 14. The dolly dispenser 20 is for receiving, storing, and dispensing dollies D. In operation, the dollies D are dispensed one-at-a-time onto the conveyor 14. Once dispensed onto the conveyor 14, each dolly D is conveyed downstream to other sections (see FIG. 1) of the system 10. The size and type of dolly D can vary, and in the example depicted each dolly D has a support slab E1 on wheels E2.

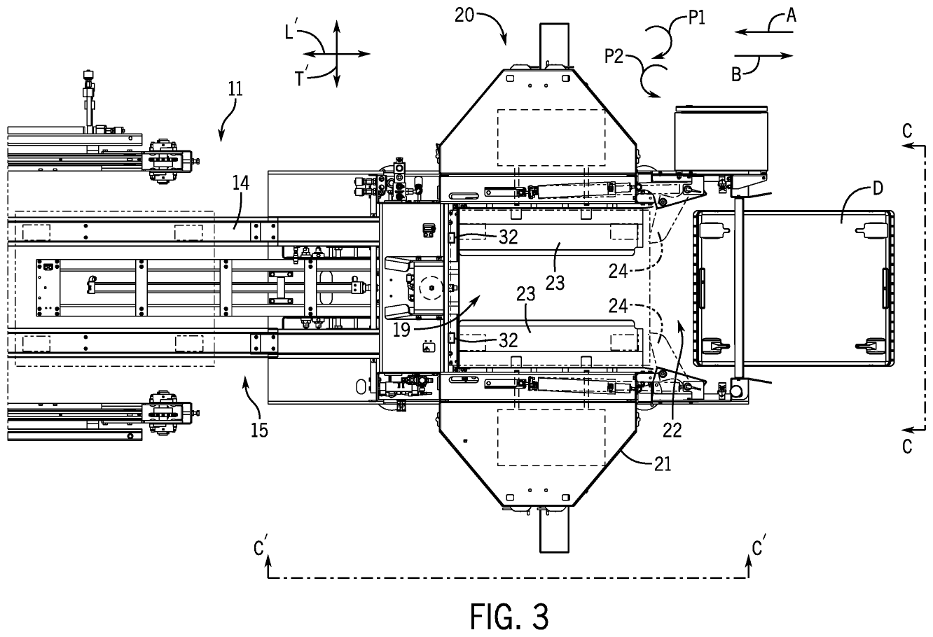

The dolly dispenser 20 has a housing 21 that protects the internal components of the dolly dispenser 20 and defines a cavity 19 in which a stack of dollies D are received and stored. The housing 21 has an inlet 22 through which the dollies D are received, manually (or with a forklift) into the housing 21. In particular, the stack of dollies D is placed into the housing 21 by pushing a stack on dollies D through the inlet 22 and onto one or more platforms 23 (FIG. 3) that are in the cavity 19. As will be further described further hereinbelow, the platforms 23 are vertically moveable into different positions in the cavity 19 to thereby vertically raise or lower the stack of dollies D in the cavity 19.

FIG. 3 depicts the stack of dollies D being pushed through the inlet 22 and onto the platforms 23 (see arrow A). As the dollies D are pushed through the inlet 22, a door 24 (shown in dashed lines) pivotally coupled to each side of the housing 21 inwardly pivot in a first direction (see arrow P1) such that the dollies D can be pushed into the cavity 19. After the dollies D are pushed into the cavity 19, the doors 24 pivot in an opposite, second direction (see arrow P2) to thereby prevent the dollies D from inadvertently moving off the platforms 23 and/or out of the cavity 19. In certain examples, the doors 24 are biased in the second direction (see arrow B) such that the doors 24 automatically outwardly pivot in the second direction (see arrow P2) after the dollies D are pushed into the cavity 19. In other examples, the doors 24 are moved by an actuator (not shown) that is controlled by the controller 200 (FIG. 1) as the dollies D are pushed into the cavity 19. Note that the actuator mentioned above, as well as the other actuators described hereinbelow, can be any suitable devices and/or systems such as stepper motors, pneumatic cylinders with a corresponding air system, and hydraulic cylinders with a corresponding hydraulic system, and the like.

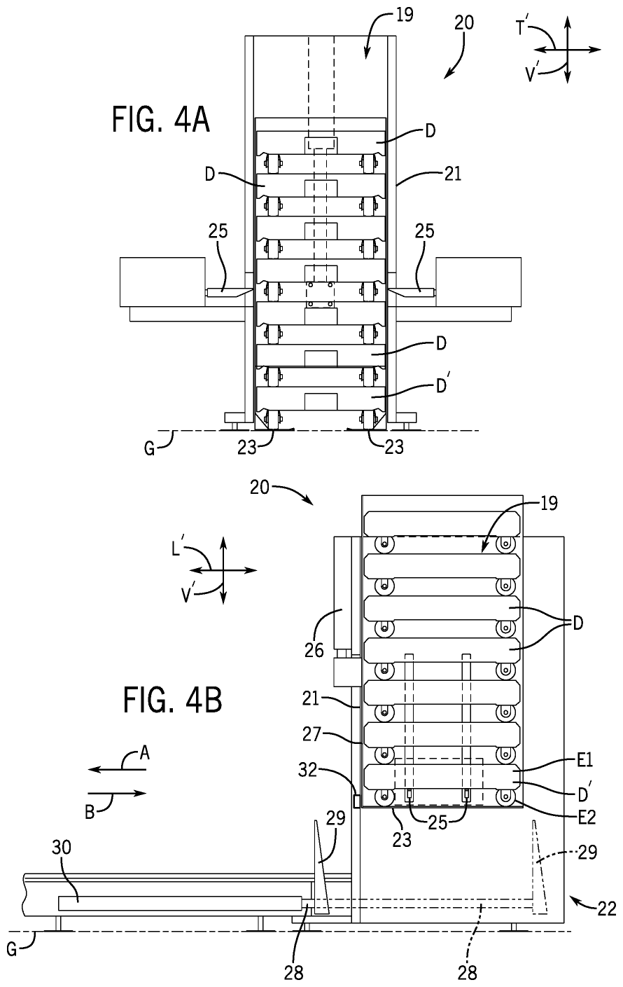

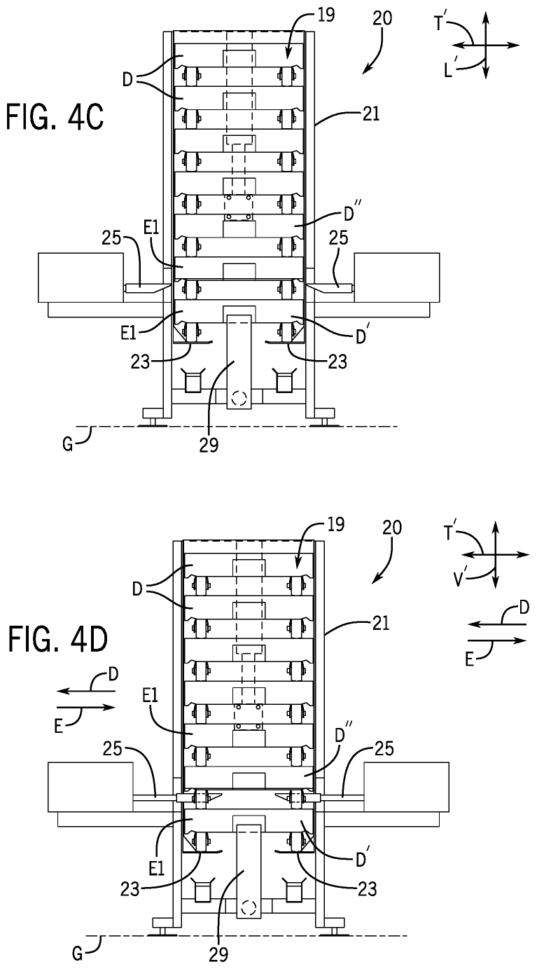

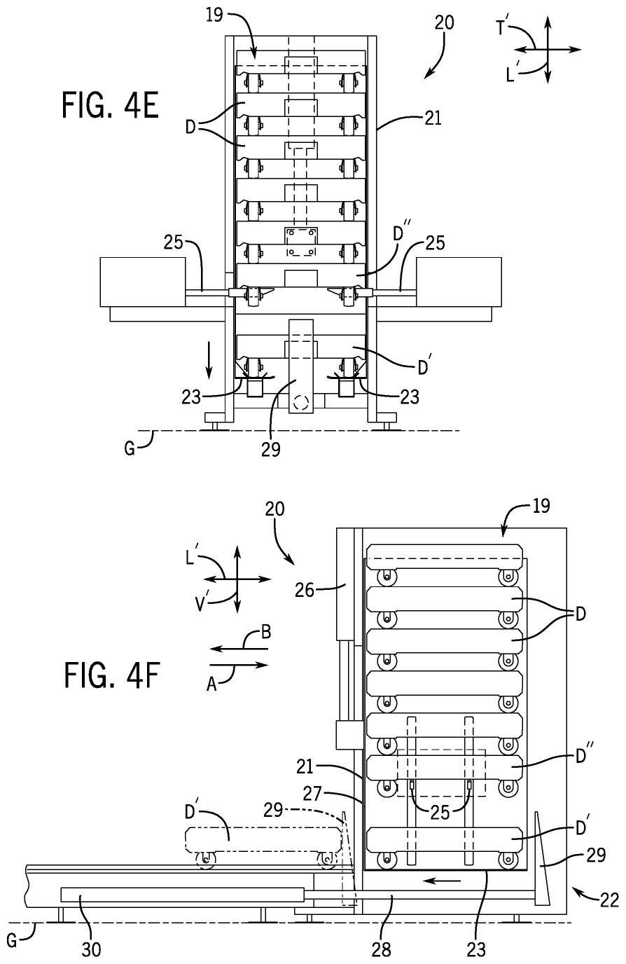

An example operational sequence for dispensing one dolly D from the dolly dispenser 20 onto the conveyor 14 is described hereinbelow with respect to FIGS. 4A-4F.

FIG. 4A is an end view of the dolly dispenser 20 (see generally at line C-C on FIG. 3) with a stack of dollies D received into the housing 21 and on the platforms 23. The platforms 23 are in a lowered position on the ground G. Opposing arms 25 on the sides of the housing 21 are in retracted positions such that the arms 25 do not extend into the cavity 19 and do not contact the dollies D. The operation of the arms 25 is further described hereinbelow. In certain examples, the shape of the arm 25 can vary, and in the example depicted the arms 25 have a wedge-shaped or tapered end. In certain examples, the dolly dispenser 20 includes arm sensors (not shown) that sense the position of the arms 25. The arm sensors are connected to the controller 200, and the arm sensors generated sensor data indicative of the position of the arms 25 and the sensor data is used by the controller 200 during operation of the system 10.

Referring now to FIG. 4B (which is a side view of the dolly dispenser 20 generally at line C′-C′ on FIG. 3), the platforms 23 are moved from the lowered position (FIG. 4A) to the raised position (FIG. 4B) such that the platforms 23 vertically lift the stack of dollies D off the ground G. Vertical movement of the platforms 23 is controlled by the controller 200 (FIG. 1) which actuates an actuator 26 to thereby vertically move the platforms 23. The platforms 23 are coupled to the actuator 26 via a frame 27 that is positioned alongside the housing 21. In the raised position, the platforms 23 are vertically below the arms 25 such the slab E1 of the lowermost dolly D′ in the stack of dollies D is vertically above the arms 25.

After the stack of dollies D is vertically lifted as described above, a rake member 28 is moved in the second direction (see arrow B) from a retracted position (see solid lines) in which the rake member 28 is outside the cavity 19 to an extended position (see dashed lines) in which the rake member 28 extends through the cavity 19. Specifically, the controller 200 (FIG. 1) controls an actuator 30 to thereby move the rake member 28 between the extended position (see dashed lines) and retracted position (see solid lines). The rake member 28 depicted in FIG. 4B has an elongated rod with a first end connected to the actuator 30 and a vertical finger member 29 connected to an opposite, second end of the elongated rod. The vertical finger member 29 extends in the vertical direction toward the top of the housing 21. In certain examples, the rake member 28 is coupled to the underside of the conveyor 14 and extends thereunder when the rake member 28 is in the retracted position (see solid lines).

Referring now to FIG. 4C, the platforms 23 are vertically downwardly moved into an intermediate position by the actuator 26 (FIG. 4B) such that the stack of dollies D is vertically lowered. As such, the lowermost dolly D′ is vertically below the arms 25. In the intermediate position, the platforms 23 are vertically between the raised position (see FIG. 4B) and the lowered position (see FIG. 4A) and the arms 25 are aligned with the space between the lowermost dolly D′ and the next immediately vertically adjacent dolly D″ (e.g., the space between the slab E1 of the lowermost dolly D′ and the slab E1 of the next immediately vertically adjacent dolly D″). In certain examples, the dolly dispenser 20 includes a sensor 32 (FIG. 3) the senses the position of at least one of the platforms 23. The sensor 32 is connected to the controller 200 (FIG. 1) and generates sensor data that is processed by the controller 200 such that the controller 200 can determine the position of the platforms 23 and/or the dollies D. In one example, the sensor 32 is positioned on the housing 21 and at a selected vertical position such that when the platforms 23 are in the raised position (FIG. 4B) the sensor 32 is vertically aligned with the platforms 23 and thereby senses the platforms 23. In other examples, the sensor 32 is configured to sense the presence of dollies D and/or number of dollies D remaining in the dolly dispenser 20. The sensor 32 can be any suitable device capable of sensing the platforms 23 and/or the dollies D, such as a laser sensor or a proximity sensor. In another example, the sensors 32 are for sensing the presence or absence of dollies D in the dolly dispenser 20.

Referring now to FIG. 4D, once the platforms 23 are in the intermediate position (see FIG. 4C), the arms 25 are moved from the reacted position (see FIG. 4C) in which the arms 25 are outside the cavity 19 to an extended position (FIG. 4D) in which the arms 25 extend (see arrows D) into the cavity 19 and between the lowermost dolly D′ and the next immediately vertically adjacent dolly D″. The controller 200 controls the arms 25 by actuating actuators (not shown) which move the arms 25.

After the arms 25 are moved to the extended position (FIG. 4D), the actuator 26 (see FIG. 4B) is actuated by the controller 200 to further vertically downwardly move the platforms 23 into a dispensing position, as shown in FIG. 4E. Accordingly, the lowermost dolly D′ can be dispensed onto the conveyor 14. The dispensing position is vertically lower than the intermediate position (FIG. 4C) and vertically above the lowered position (FIG. 4A). As the platforms 23 are lowered into the dispensing position, the arms 25 vertically support (e.g., vertically suspend) the stack of dollies D in the housing 21 and prevent the stack of dollies D from vertically moving with the platforms 23.

Referring now to FIG. 4F, after the platforms 23 are moved into the dispensing position (see FIG. 4E) the rake member 28 is moved by the actuator 30 from the extended position (solid lines) to the retracted position (see FIG. 4B). As the rake member 28 is moved from the extended position (note the vertical finger member 29 shown in solid lines when the rake member 28 is in the extended position) to the retracted position (note the vertical finger member 29 is shown in dashed lines when the rake member 28 is in the retracted position), the vertical finger member 29 passes between the platforms 23 and contacts the lowermost dolly D′ and thereby “pulls” the lowermost dolly D′ in the first direction (see arrow A) off the platforms 23 and onto the conveyor 14 (note the lowermost dolly D′ is depicted in dashed lines when pulled onto the conveyor 14). As such, the lowermost dolly D′ is dispensed onto the conveyor 14 and therefore the dolly D can be conveyed downstream to other sections of the system 10 by the conveyor 14 (FIG. 1).

After the lowermost dolly D′ is dispensed onto the conveyor 14, the rake member 28 is moved back to the extended position (see FIG. 4F) and the platforms 23 are moved to the raised position (see FIG. 4B). The arms 25 are then moved into the retracted position (see arrows E on FIG. 4D) such that the stack of dollies D is again vertically supported on the platforms 23. The operational sequence for dispensing a dolly D described above is then repeated such that the next lowermost dolly D in the stack of dollies D can be dispensed onto the conveyor 14. Once each dolly D in the stack of dollies D is dispensed, the platforms 23 are moved to the lowered position (FIG. 4A) such that another stack of dollies D can be pushed into the cavity 19.

Pallet Dispenser

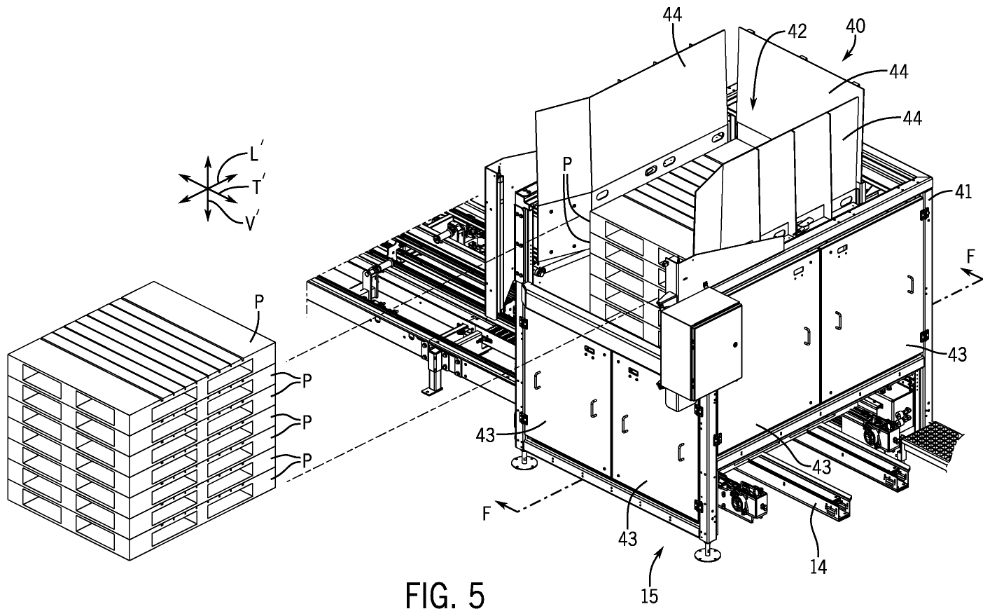

FIG. 5 depicts the pallet dispenser 40 at the upstream end 15 of the conveyor 14 and downstream relative to the dolly dispenser 20 (as shown in FIG. 1). A person of ordinary skill in the art will recognize that in other examples the pallet dispenser 40 can be upstream relative to the dolly dispenser 20.

The pallet dispenser 40 is for receiving, storing, and dispensing pallets P onto the conveyor 14. Once dispensed onto the conveyor 14, the pallets P are conveyed downstream by the conveyor 14 to other sections (see FIG. 1) in the system 10. The size and type of pallet P can vary. FIG. 5 depicts a stack of pallets P which is partially loaded into the pallet dispenser 40. The pallets P can be manually loaded into the pallet dispenser 40 or loaded into the pallet dispenser 40 with a forklift.

The pallet dispenser 40 extends across (e.g., straddles) the conveyor 14 such that the pallets P are vertically dispensed onto the conveyor 14 one pallet at a time (described hereinbelow). A housing 41 defines a cavity 42 in which the pallets P are received, and the housing 41 has a plurality of access doors 43 for accessing the cavity 42 and other components of the pallet dispenser 40. Panels 44 funnel the pallets P into the cavity 42.

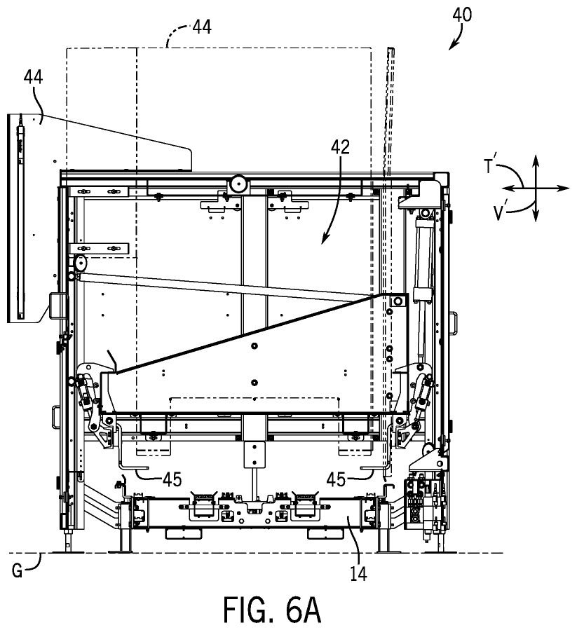

FIGS. 6A-6B are cross-sectional views of the pallet dispenser 40 (see line F-F on FIG. 5). FIG. 6A depicts an empty pallet dispenser 40, and FIG. 6B depicts the pallet dispenser 40 loaded with a stack of pallets P. Generally, the pallet dispenser 40 has arms 45 that are configured to vertically suspend the pallets P above the conveyor 14 and selectively dispense the lowermost pallet P′ onto the conveyor 14. During operation of the system 10, the pallets P are retained above the conveyor 14 and in the pallet dispenser 40 so that the dollies D dispensed onto the conveyor 14 by the dolly dispenser 20 (FIG. 4F) can be freely conveyed downstream by the conveyor 14. That is, the dollies D on the conveyor 14 freely pass through or under the pallet dispenser 40. An example of a conventional pallet dispenser is commonly found in a conventional palletizing system.

Loading System

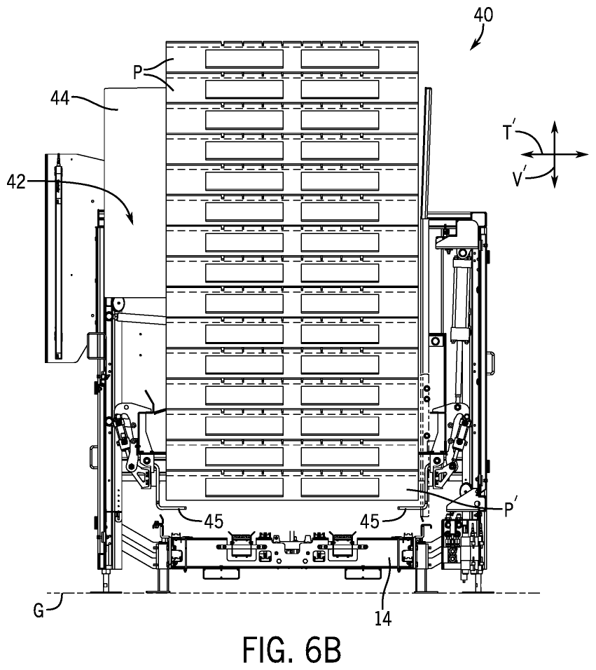

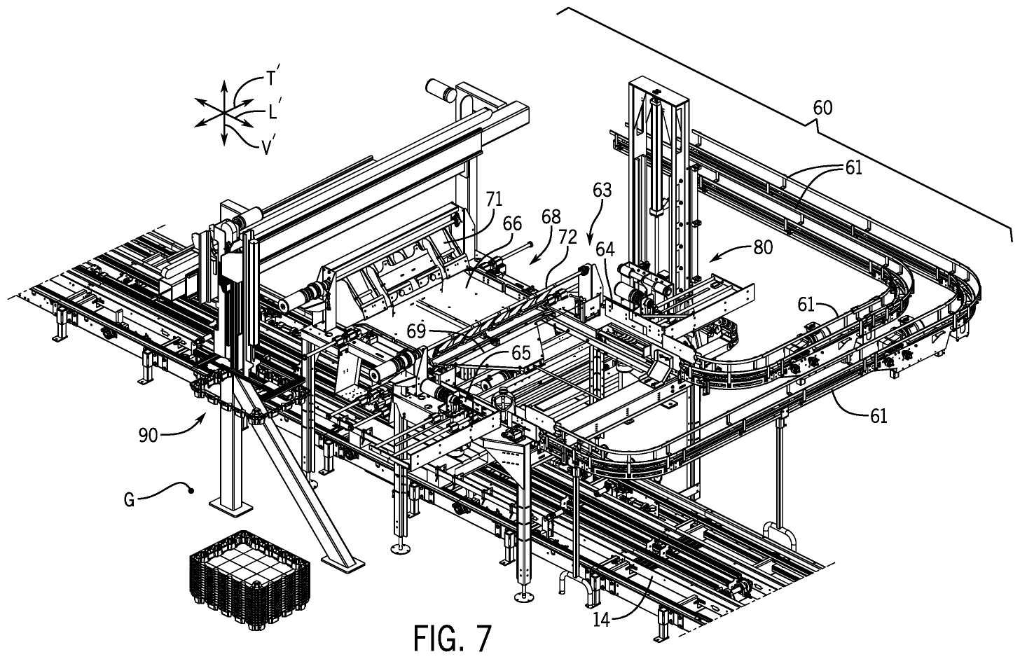

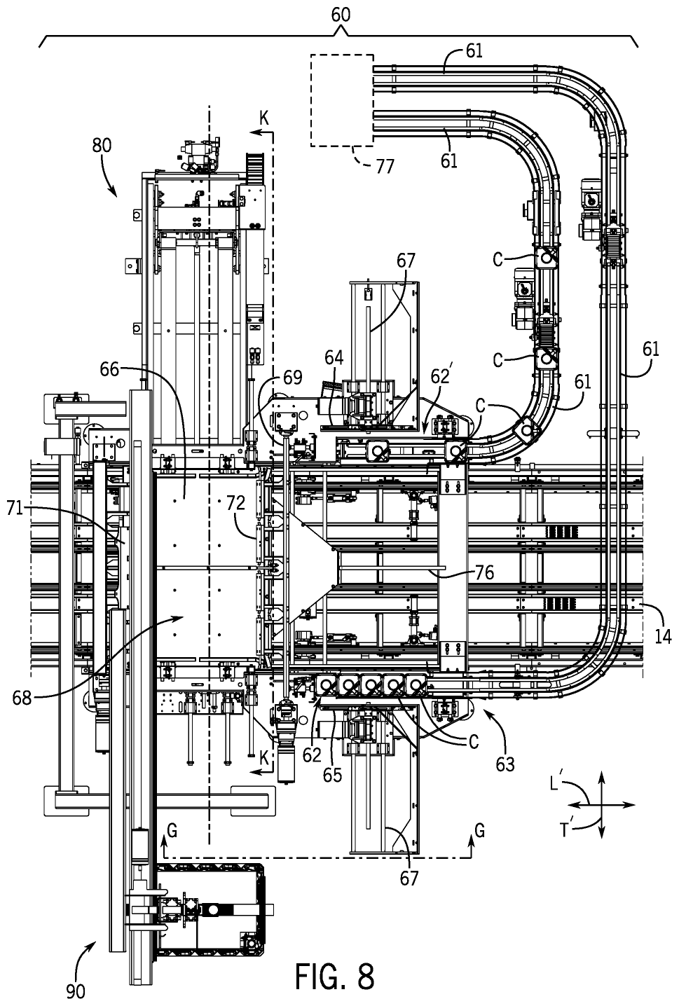

FIGS. 7-8 depicts the loading system 60 in greater detail. The loading system 60 is for receiving containers C (FIG. 8), such as gallon milk jugs, from a bottling machine 77 (see dashed box on FIG. 8). The containers C are conveyed by a tabletop conveyor 61 to an organizing system 63 of the loading system 60 that organizes the containers C into a layer of containers on a slip sheet 66 (described hereinbelow in greater detail). The organizing system 63 is vertically above the conveyor 14 (FIG. 7) such that the dollies D and the pallets P (see FIG. 1) are conveyed under the organizing system 63.

Referring specifically to FIG. 8, the tabletop conveyor 61 is shown extending from a bottling machine 77 to the organizing system 63. In particular, the tabletop conveyor 61 is arranged to convey the containers C to opposing lateral sides of the organizing system 63 that correspond with the opposing lateral sides of the conveyor 14. The tabletop conveyor 61 has a pair of end sections 62 in which individual containers C are collected into a row (e.g., the containers C are longitudinally aligned next to each other in the end sections 62). For example, five containers C are collected together in the end section 62 (note that in FIG. 8 all five containers C have not yet been conveyed to the end section 62′).

Each end section 62 is adjacent to lateral pushers, namely a first lateral pusher 64 and a second lateral pusher 65, that are configured to push rows of containers C collected in the end sections 62 onto a slip sheet 66 (described further herein; note that the slip sheet 66 is shown in an extended position in FIG. 8). The lateral pushers 64, 65 are moved into different positions by drive assemblies 67 that are controlled by the controller 200 (see FIG. 1). Each drive assembly 76 includes a stationary motor that drives a timing belt that is connected to one the lateral pushers 64, 65. When the stationary motor is activated, the timing belt is moved in different directions such that the lateral pushers 64, 65 are moved between different positions. In certain examples, the stationary motor of the drive assembly 76 is a servo motor, and accordingly, the precise location of the slip sheet 66 can be determined by the controller 200 based on the amount of time the servo motor is activated. The slip sheet 66 is also moved by a similar drive assembly 76. In certain examples, the slip sheet 66 is a planar plate with opposite ends.

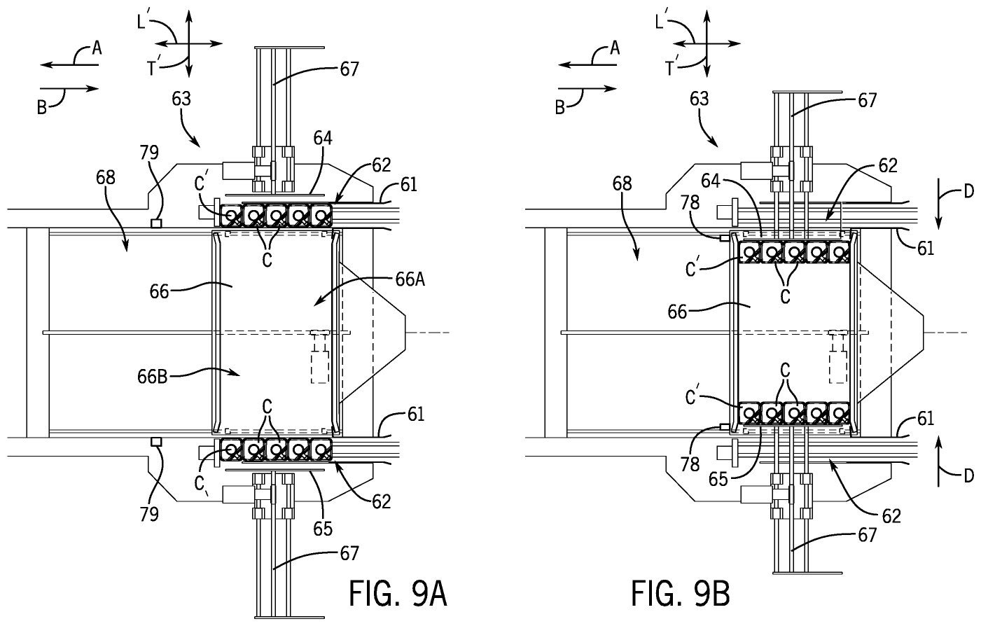

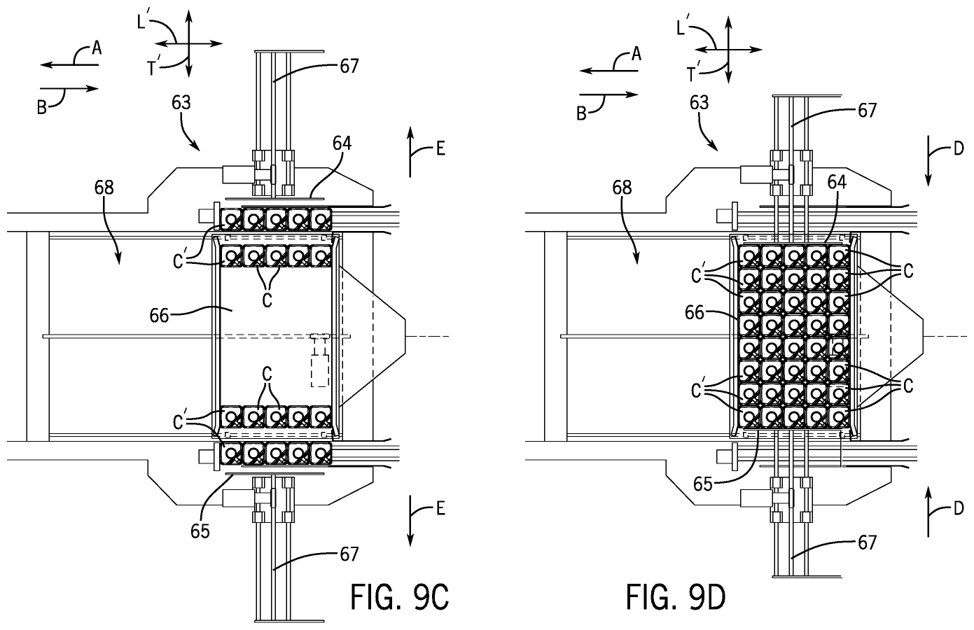

An example operational sequence for organizing multiple containers C on the slip sheet 66 is described hereinbelow with respect to FIGS. 9A-D, which are top-down schematic views of the organizing system 63 shown in FIGS. 7-8.

FIG. 9A depicts a series of containers C collected next to each other in each end section 62 of the tabletop conveyor 61. The slip sheet 66 is in a retracted position and the lateral pushers 64, 65 are each in a retracted position. The slip sheet 66 has a first end or upstream end 66A and an opposite second end or downstream end 66B.

Referring to FIG. 9B, the lateral pushers 64, 65, which are moved by drive assemblies 67, push the containers C in the lateral direction (see arrows D) off the tabletop conveyor 61 and onto the slip sheet 66. As such, the lateral pushers 64, 65 are in a first extended position, as shown in FIG. 9B.

As depicted in FIG. 9C, the lateral pushers 64, 65 are then laterally moved (see arrows E) in the opposite direction back to the retracted position and away from each other by the drive assemblies 67. As such additional containers C can be conveyed into the end sections 62 of the tabletop conveyor 61. The sequence of moving the lateral pushers 64, 65 into and between the retracted position (FIG. 9C) and the extended position (FIG. 9B) is repeated until the slip sheet 66 is filled with the predetermined number of containers C, such as the five-by-eight layer of containers C shown in FIG. 9D. A person of ordinary skill in the art will recognize that as each row of containers C (e.g., a set of five containers C) is laterally moved onto the slip sheet 66 by the lateral pushers 64, 65, the containers C on the slip sheet 66 are further laterally inwardly moved (see arrow D on FIG. 9D) by the containers C that are pushed onto the slip sheet 66. The number and/or pattern of the containers C pushed onto the slip sheet 66 can vary, and in the example depicted, a five-by-eight layer of containers C is formed on the slip sheet 66. In another example, a four-by-six layer of containers C is formed on the slip sheet 66. A person of ordinary skill in the art will recognize that the number and/or pattern of containers C organized on the slip sheet 66 can vary (e.g., 6×8, 5×4, or 4×6) and be changed based on the transport structure, e.g., dolly D or pallet P (FIG. 1), that will be loaded with containers C. In certain examples, the pattern and number of containers C is dependent on the size and shape of the pallet P or the dolly D to be loaded. The lateral pushers 64, 65 may be simultaneously or alternatively moved, and in certain examples, the lateral pushers 64, 65 articulate as they are moved such that the length of the lateral pushers 64, 65 increases or decreases.

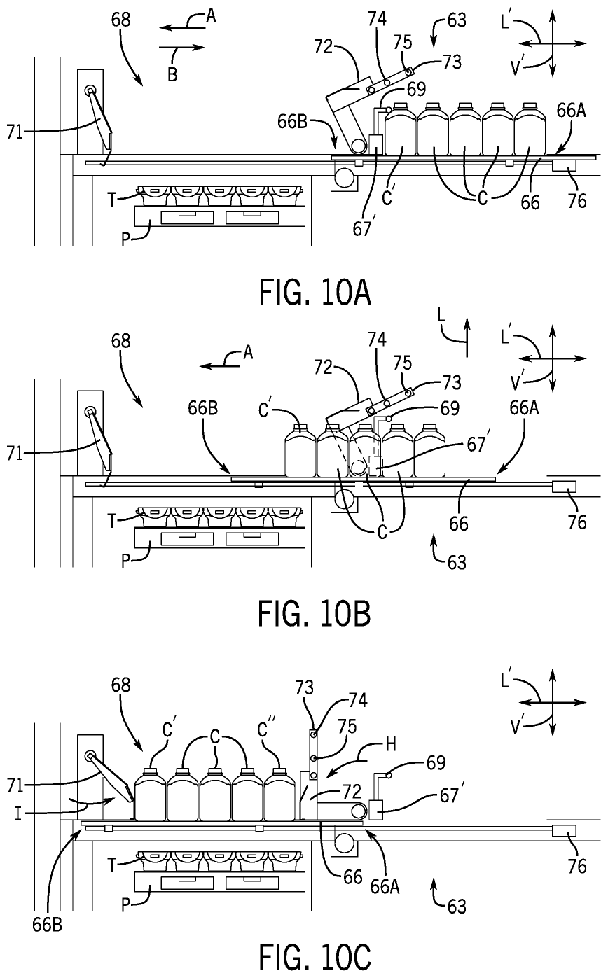

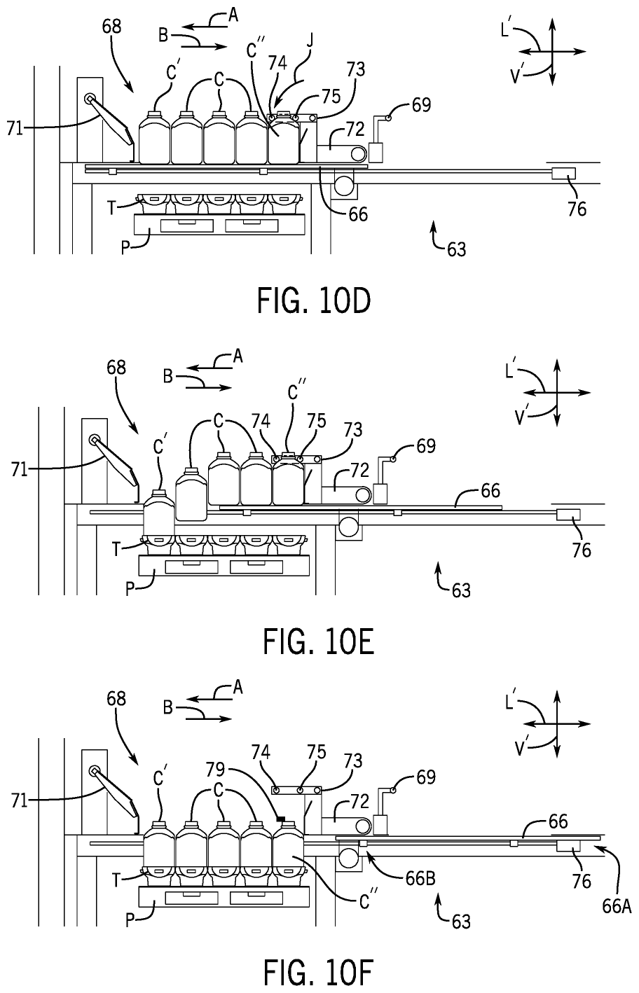

After the containers C have been pushed on the slip sheet 66 as described above, the slip sheet 66 and the containers C are moved downstream (see arrow A) where the containers C are loaded onto a pallet P or a dolly D (described hereinbelow). An example operational sequence of moving and loading layers of containers C onto the slip sheet 66 is described hereinbelow with respect to FIGS. 10A-10F, which are side schematic views of the organizing system 63 shown in FIGS. 7-8 (generally shown at line G-G on FIG. 8). Note that while FIGS. 10A-10F depict a pallet P being loaded with layers of containers C, a dolly D may be loaded with layers of containers C.

FIG. 10A depicts the containers C on the slip sheet 66 and the slip sheet 66 in the retracted position as described above (see FIG. 9D). A loading area 68 is immediately downstream from the slip sheet 66 and the containers C.

The organizing machine 63 has a first guide member 69 for guiding the containers C on the slip sheet 66 as the lateral pushers 64, 65 push the containers C (described above). The first guide member 69 extends in the lateral direction (see FIG. 8) across the slip sheet 66, and an actuator 67′, that is controlled by the controller 200 (FIG. 1), vertically moves the first guide member 69 into and between a first position (FIG. 10A) and a second position (FIG. 10B). The first guide member 69 is in the first position (FIG. 10A) as the lateral pushers 64, 65 laterally push the containers C onto the slip sheet 66. Accordingly, as each row of containers C is moved onto the slip sheet 66, the leading containers C′ slide along the first guide member 69. Specifically, when the first guide member 69 is in the first position (FIG. 10A), upper portion or top of the leading container C′ contacts and slides along the first guide member 69. The first guide member 69 prevents the containers C, on the slip sheet 66 from inadvertently falling off the second end or downstream end 66B of the slip sheet 66 and further helps maintain the containers C in a tight layer pattern on the slip sheet 66.

Before the containers are longitudinally moved downstream (see arrow A), the actuator 67′ vertically upwardly moves (see arrow L on FIG. 10B) the first guide member 69 into the second position (FIG. 10B). Accordingly, when the slip sheet 66 is moved in the first direction (see arrow A) the containers C clear (e.g., pass under) the first guide member 69 and are therefore longitudinally moved downstream (see arrow A and FIG. 10B) with the slip sheet 66 (described further herein).

FIG. 10B depicts the slip sheet 66 longitudinally moved in the first direction (see arrow A) away from a retracted position (FIG. 10A) such that the containers C are partially in the loading area 68. The slip sheet 66 is moved in the first direction (see arrow A) by the drive assembly 76 (described above). As the slip sheet 66 is moved, the containers C move with the slip sheet 66 and pass under the first guide member 69. FIG. 10C depicts the slip sheet 66 moved into an extended position (see also FIG. 8) such that the containers C are in the loading area 68.

Referring to FIG. 10C, the organizing system 63 has a first brace member 71 that is moved (e.g., pivoted) (see arrow I) into contact with the leading containers C′ and then a second brace member 72 that is moved (e.g., pivoted) (see arrow H) into contact with the trailing containers C″ (e.g., the trailing containers C″ are the upstream-most containers C″ in the layer of containers C) when the slip sheet 66 is in the extended position. Like the first guide member 69, the brace members 71, 72 extend in the lateral direction (see FIG. 8) vertically above and across the conveyor 14. The brace members 71, 72 are connected to actuators (not shown) that are controlled by the controller 200 (FIG. 1). The brace members 71, 72 are pivoted into and between first positions (see FIG. 10B) and second positions (see FIG. 10C), respectively, to thereby sandwich the containers C therebetween. In certain examples, the brace members 71, 72 contact and/or compress the containers C to thereby further align the containers C relative to each other. Note that when the second brace member 72 is in the first position (see FIG. 10A-10B) the containers C are conveyed past (e.g., under) the second brace member 72.

FIG. 10D depicts a guide arm 73 of the second brace member 72 moved into a second position (described herein). The guide arm 73 extends along the second brace member 72 (see also FIG. 8), and the guide arm 73 has a pair of elongated members 74, 75 that help guide the trailing containers C″ onto the pallet P, as will be described herein. Specifically, the guide arm 73 is moved (e.g., pivoted) (see arrow J) into and between the first position (see FIG. 10C) in which the guide arm 73 vertically extends away from the containers C and a second position (see FIG. 10D) in which the guide arm 73 laterally extends along the tops of the trailing containers C″. In particular, when the guide arm 73 is in the second position one elongated member 74, 75 is on either side of the tops of the trailing containers C″. The elongated member 74, 75 prevent the tops of the upstream-most containers C″ from moving (e.g., tipping, rotating, pivoting) out of alignment as the upstream-most containers C″ are loaded onto the pallet P or dolly P, as will be described below. Note that guide arm 73 is moved by one or more actuators (not shown) that are controlled by the controller 200 (FIG. 1).

FIG. 10E depicts the slip sheet 66 moved by the drive assembly 76 in the second direction (arrow B) from the extended position (FIG. 10D) toward the retracted position (FIG. 10A). As the slip sheet 66 is moved, the second brace member 72 prevents the containers C from sliding with the slip sheet 66 and accordingly, the containers C, starting with the leading containers C′, fall off the slip sheet 66 and vertically drop onto a pallet P or dolly D that is vertically below the containers C. In the example depicted, a pallet P with a tray T receives the containers C as the containers C fall off the slip sheet 66. Note that in other examples a dolly D is used. Each lateral row of containers C in the layer of the container C (see FIG. 9D) consecutively vertically falls (e.g., drops) off the slip sheet 66 onto the pallet P as the slip sheet 66 is moved towards the retracted position, as seen in FIG. 10F. Accordingly, the entire layer of containers C is loaded onto the pallet P. In certain examples, sensors 79 (see FIGS. 9A and 10F) are included to sense if the containers C are incorrectly loaded onto the pallet P. The sensors 79 (e.g. laser sensors) are vertically positioned at a predetermined vertical height just above the tops of the container C when the containers C are loaded onto the pallet P (e.g., the sensors “shoot” across the tops of the containers C). If the containers C are incorrectly loaded on the pallet P, the tops of the containers C will extend above the predetermined vertical height and accordingly, the sensors 79 will sense presence of the containers C. The sensors 79 generate data and the controller 200 (FIG. 1), which is connected to the sensors 79, will stop the container loading operation and/or alert the operator of the error until the position of the containers C on the pallet P is corrected (e.g., the error is corrected by moving the misaligned containers into a proper load position such that the containers are vertically below the predetermined vertical height). The present inventors have recognized that the containers C should not extend above the predetermined vertical height and should define a flat, level plane across the tops of the containers C to ensure that additional layers of containers C and/or trays T can be properly loaded onto the pallet P. Failure to maintain flat, level plane across the tops of the containers C could result in errors in the loading process and/or a loaded pallet P that is unstable.

The present inventors have discovered that as the slip sheet 66 is moved in the second direction (see arrow B) the leading containers C′ tend to move (e.g., tilt, tip, rotate) in the first direction (see arrow A) which tends to cause the bottoms of the leading containers C′ to become misaligned with the pallet P and/or tray T. This may result in misalignment of the leading containers C′ on the pallet P, the leading containers C′ falling off the pallet P, and/or the leading containers C′ preventing the other containers C from properly falling off the slip sheet 66 onto the pallet P. Accordingly, present inventors have found it advantageous to use the first brace member 71 to prevent movement (e.g., tilting, tipping, rotating) of the leading containers C′ and thereby vertically guide the leading containers C′ onto the pallet P. That is, the first brace member 71, which is described above, guides the leading containers C′ into the correct position on the pallet P as the slip sheet 66 is moved and the leading containers C′ fall off the slip sheet 66.

Similarly, the present inventors have also discovered that as the slip sheet 66 is moved in the second direction (see arrow B) the trailing containers C″ also tend to move (e.g., tilt, tip, rotate) in the first direction (see arrow A) which tends to cause the bottom of the trailing containers C″ to become misaligned with the pallet P and/or tray T. Accordingly, the elongated members 74, 75 of the guide arm 73 (described above) prevent the tops of the trailing containers C″ from moving (e.g., tilting, tipping, rotating) and thereby guide the trailing containers C″ as the trailing containers C″ fall off the slip sheet 66 and onto the pallet P.

In certain examples, the slip sheet 66 includes deflectors 78 (FIG. 9B) that deflect or guide the containers C falling onto the pallet P. The deflectors 78 are connected to the underside of the slip sheet 66 and extend away from the downstream end 66B of the slip sheet 66. The deflectors 78 prevent the containers C from falling in the lateral direction away from the pallet P. In certain examples, the deflectors 78 are inwardly sloped toward each other. The deflectors 78 can be manually removed from the slip sheet 66 and repositioned on the slip sheet 66 to thereby accommodate loading of both pallets P and dollies D. In certain examples, the deflectors 78 are connected to an actuator (not shown) such that the deflectors 78 can be automatically moved along the slip sheet 66.

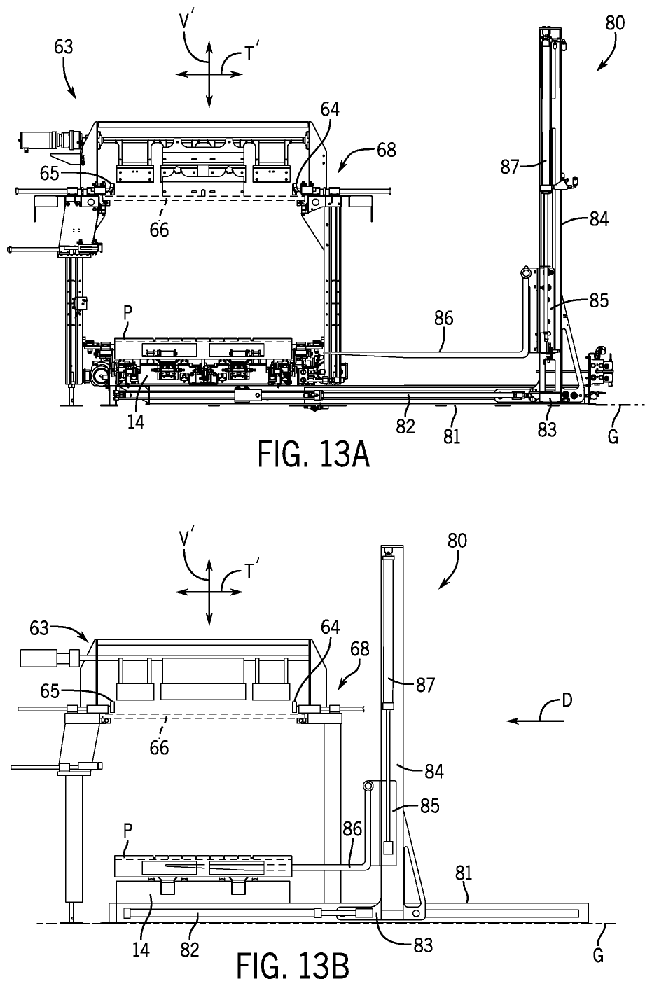

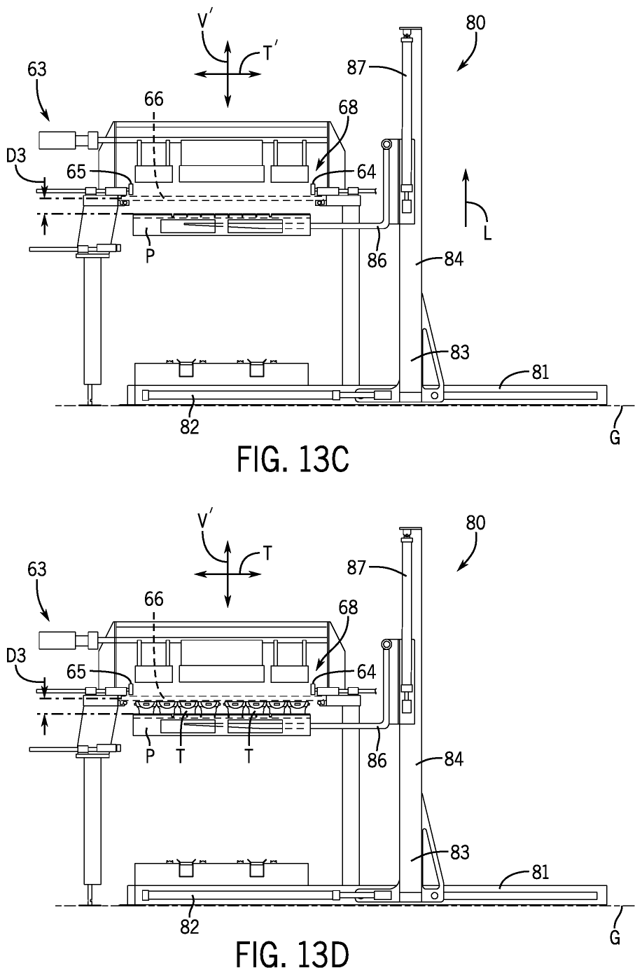

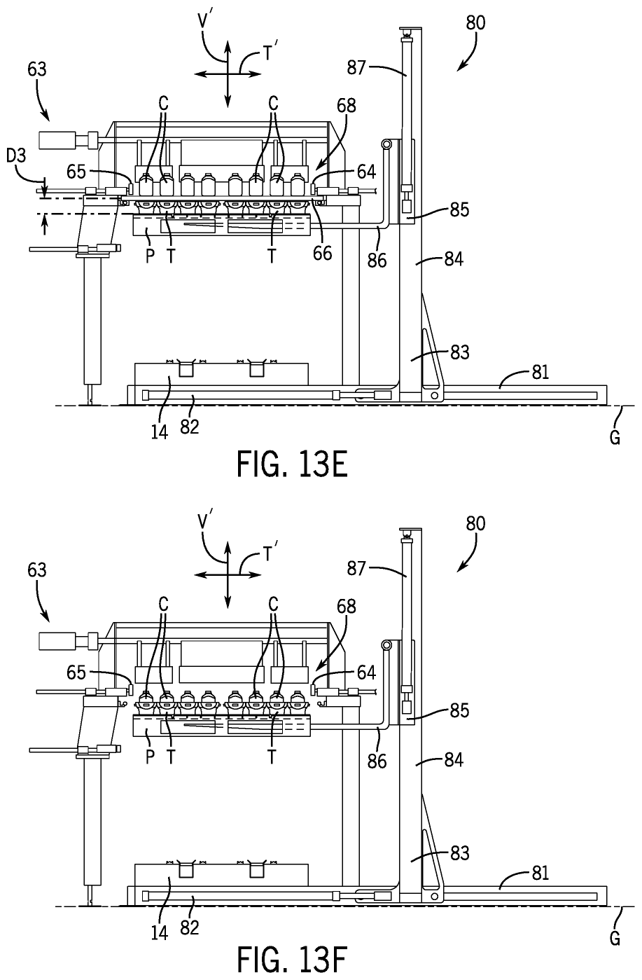

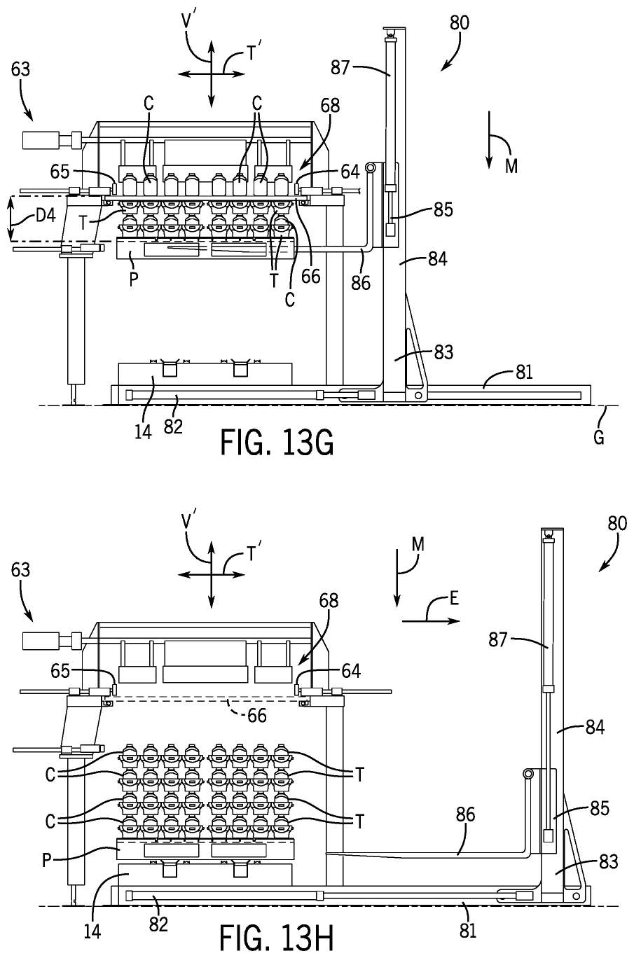

After the slip sheet 66 is moved to the retracted position (FIG. 10F), additional containers C are organized onto the slip sheet 66, as described above, to form additional layers of containers C that are subsequently loaded onto the containers C that are already loaded on the pallet P until the pallet P is fully loaded (see FIG. 13H). As additional layers of containers C are loaded onto the pallet P, the first guide member 69, the guide arm 73, and the brace members 71, 72 are moved into and between their various positions (as described above).

Lift Apparatus

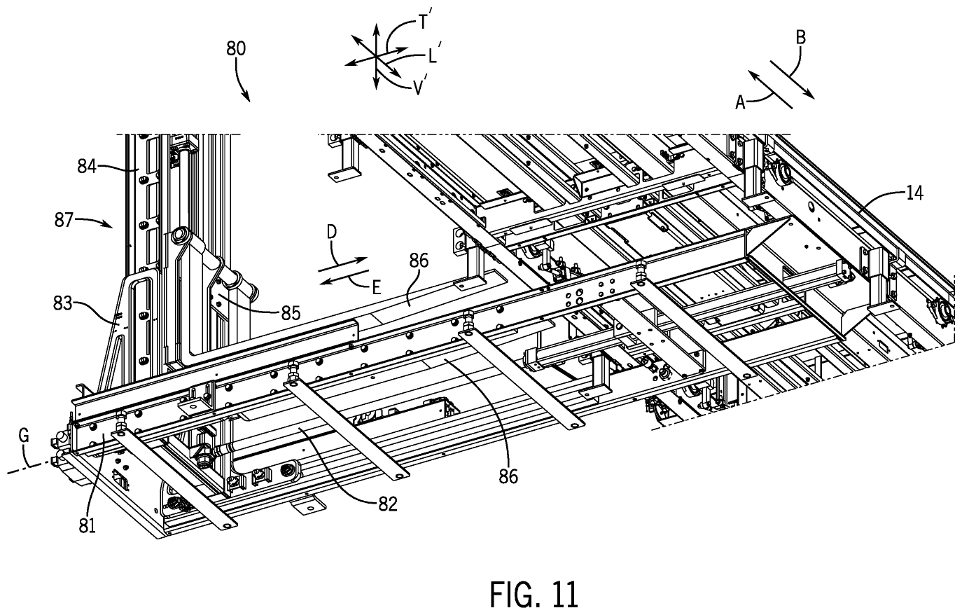

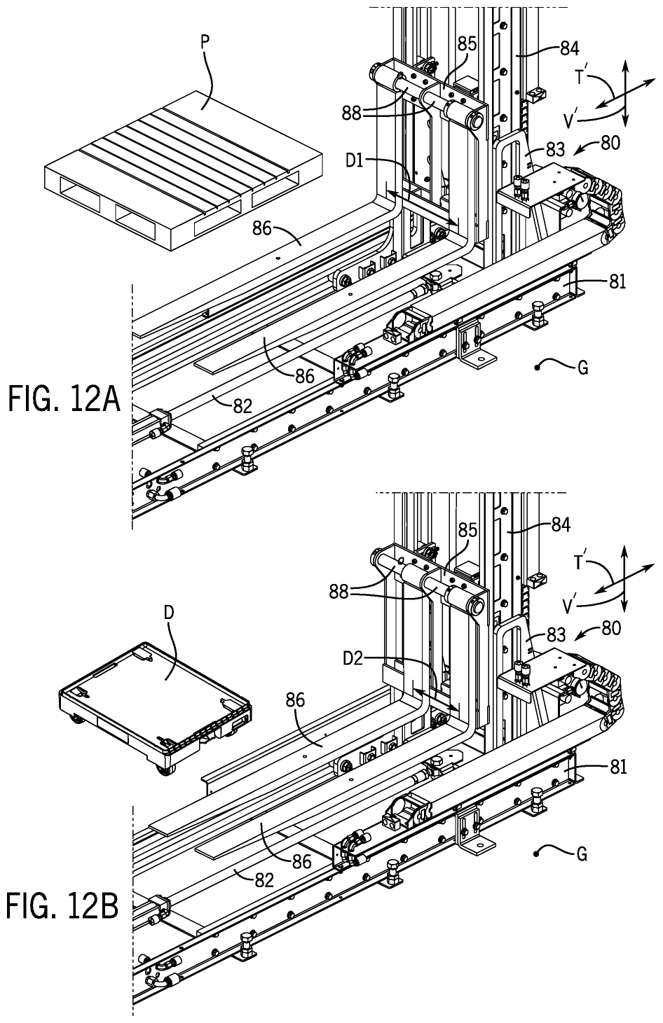

Referring to FIG. 11, the loading system 60 (see also FIG. 8) includes a lift apparatus 80 for lifting the pallet P or dolly D off of the conveyor 14, incrementally lowering the pallet P or the dolly D toward the conveyor 14 as layers of containers C are loaded onto the pallet P or the dolly D (as described above), and placing the loaded pallet P or the dolly D back onto the conveyor 14. The lift apparatus 80 has a frame 81 on the ground G (FIG. 12A) that extends in the lateral direction away from the conveyor 14. An actuator 82 is positioned on the frame 81 and is for laterally moving a sled 83 relative the conveyor 14 (see arrows D and E). That is, the actuator 82 is controlled by the controller 200 (FIG. 1) such that actuator 82 moves the sled 83 laterally toward the conveyor 14 (see arrow D) and away from the conveyor 14 (see arrow E). The sled 83 slides along the frame 81 and has a tower 84 that vertically extends away from the ground G (FIG. 12A) and the frame 81. A carriage 85 is coupled to the tower 84 and is configured to vertically slide along the tower 84 into and between different positions to thereby change the vertical position of a pair of forks 86 which are coupled to the carriage 85 (described hereinbelow). An actuator 87 (FIG. 13A) on the tower 84 is for moving the carriage 85 along the tower 84, and the actuator 87 is controlled by the controller 200 (FIG. 1). In certain examples, the lift apparatus 80 includes sensors (not shown) that sense the position of the sled 83 and/or the carriage 85. The sensors are connected to the controller 200, and the sensors generated sensor data indicative of the position of the sled 83 and/or the carriage 85 and the sensor data is used by the controller 200 during operation of the system 10.

Referring to FIG. 12A-12B, the forks 86 are movable relative to the carriage 85 with one or more fork actuators (not shown) that are on the carriage 85 and controlled by the controller 200 (FIG. 1). In particular, the forks 86 are movable into different positions such that different pallets P or dollies D can be lifted by the forks 86. The present inventors have recognized that different pallets P and dollies D have different dimensions, sizes, and shapes such that the forks 86 should must be moved into alignment with the specific pallet P or dolly D that will be lifted. As such, the forks 86 are movable relative to each other on the carriage 85 such that the pallet P or the dolly D can be properly and safely lifted off of the conveyor 14. For examples, wooden pallets have channels between a top surface and a bottom surface into which the forks 86 can be received. In another example, the width of a plastic dolly D may be less than the width of a pallet P. Accordingly, it is advantageous to automatically (or manually) change the distance between the forks 86 to thereby accommodate different pallets P and dollies D. FIG. 12A depicts the forks 86 in the first position and having a first distance D1 between the respective centerlines of the forks 86. The first position is advantageous for lifting pallets P. As noted above, fork actuators (not shown) are capable of actuating to thereby move the forks 86 relative to each other such that the distance between the centerlines of the forks 86 can be varied. In other examples, the forks 86 are manually moved relative to each other. For example, FIG. 12B depicts the forks 86 moved into a second position such that the distance between the respective centerlines of the forks 86 is a second distance D2 that is less than the first distance D1 (FIG. 12A). Accordingly, the forks 86 in the second position are capable to safely and properly lifting a dolly D. In certain examples, the forks 86 are pivotally and/or slidably coupled to the carriage 85 via rods 88 such that the forks 86 can be manually slid along the rods 88 to thereby vary the distance between the centerlines of the forks 86.

After the forks 86 are moved into the correct position to lift the pallet P or the dolly D, the sled 83, the tower 84, and the forks 86 are moved relative to the conveyor 14 to thereby lift the pallet P or the dolly D. An example operational sequence of moving a pallet P relative to the conveyor 14, loading the pallet P pallet with containers C, and placing the loaded pallet P back onto the conveyor 14 is described hereinbelow with respect to FIGS. 13A-13F, which are side schematic views of the lift apparatus 80 shown in FIGS. 7-8 generally along line K-K on FIG. 8. A pallet P is depicted in FIGS. 13A-13F, however, a person of ordinary skill in the art will recognize that the dolly D could also be processed as described hereinbelow.

FIG. 13A depicts a pallet P conveyed to the loading system 60 by the conveyor 14 such that the pallet P is vertically directly below the loading area 68. The sled 83 is in a first position such that the forks 86 are laterally adjacent to the conveyor 14 (note that the forks 86 do not directly vertically extend above the conveyor 14). The carriage 85 is in a first position in which the forks 86 are vertically aligned with the pallet P on the conveyor 14.

FIG. 13B depicts the sled 83 laterally inwardly moved (see arrow D) into a second position such that the forks 86 are inserted into fork receiving channels defined by the pallet P. As noted above, the sled 83 is laterally moved by the actuator 82.

Next, as depicted in FIG. 13C, the carriage 85 is vertically moved (see arrow L) by the actuator 87 into a second position in which the top surface of the pallet P is positioned a first loading distance D3 from the slip sheet 66 (note that the slip sheet 66 is shown in dashed lines as the slip sheet 66 is not yet in the loading area 68). The first loading distance D3 is a distance determined by the operator based on the height of the containers C so that the containers C are properly loaded onto the pallet P. The present inventors have determined that if the first loading distance D3 is too large, the containers C may vertically drop too far and become misaligned on the pallet P. The operator of the system 10 inputs the first loading distance D3 into the controller 200 via the user input device 204 such that the controller 200 controls the actuator 87 to thereby move the carriage 85 into the second position (FIG. 13C). In certain examples, the first loading distance D3 is dependent on the size and shape of the containers C and/or the trays T placed on the pallet P. In certain examples, the section 60 has sensors (not shown) for detecting the size and shape of the containers C to thereby automatically determine the first loading distance D3 in real-time as different containers C are loaded onto the pallet P and/or as different pallets P are used.

FIG. 13D depicts an optional step of placing one or more trays T onto the pallet P. The trays T are configured to receive the containers C and thereby stabilize the containers C on the pallet P as multiple layers of containers C are loaded and stacked on the pallet P. Placement of the trays T onto the pallet P (and between layers of containers C loaded onto the pallet P) is further described hereinbelow.

FIG. 13E depicts the slip sheet 66 moved into the loading area 68 (see also FIG. 9D) such that the layer of containers C on the slip sheet 66 is vertically directly above the pallet P (see also FIGS. 10C-10D). Referring now to FIG. 13F, the slip sheet 66 (FIG. 13E) is moved, as described above, such that the first layer of containers C fall onto the trays T on the pallet P (see FIGS. 10E-10F).

Referring to FIG. 13G, after the first layer of containers C is loaded onto the pallet P, the carriage 85 is vertically downwardly moved by the actuator 87 into a third position such that an additional layer of containers C (and in some examples additional trays T) is loaded onto the pallet P. Specifically, the carriage 85 is vertically downwardly moved (see arrow M) such that the top surface of the pallet P is positioned a second loading distance D4 from the slip sheet 66. The second loading distance D4 is a distance determined by the operator based on the height of the containers C. FIG. 13G depicts the second layer of containers C on the slip sheet 66 before the second layer of containers C is loaded onto the first layer of containers C (as described above).

Referring now to FIG. 13H, the carriage 85 is vertically downwardly moved (see arrow M) so that each layer of containers C is loaded onto the pallet P. That is, the pallet P is incrementally vertically lowered such that each layer of containers C can be loaded onto the pallet P. Once the pallet P is loaded, the carriage 85 places the pallet P back onto the conveyor 14. Note that in certain examples, a layer of containers C is loaded onto the pallet P when the pallet P is placed back onto the conveyor 14. The sled 83 is laterally moved (see arrow E) back to the first position such that the forks 86 are next to the conveyor 14 and the pallet P loaded with layers of containers C can be conveyed downstream by the conveyor 14 to other downstream sections of the system 10.

Gantry Arm Machine

As noted above, trays T are optionally placed onto the pallet P and on top of each layer of containers C. FIG. 13D depicts an optional step of placing one or more trays T onto the pallet P to thereby receive and stabilize the layers of containers C stacked on top of each other. Placement of the trays T onto the pallet P and between layers of containers C is described hereinbelow.

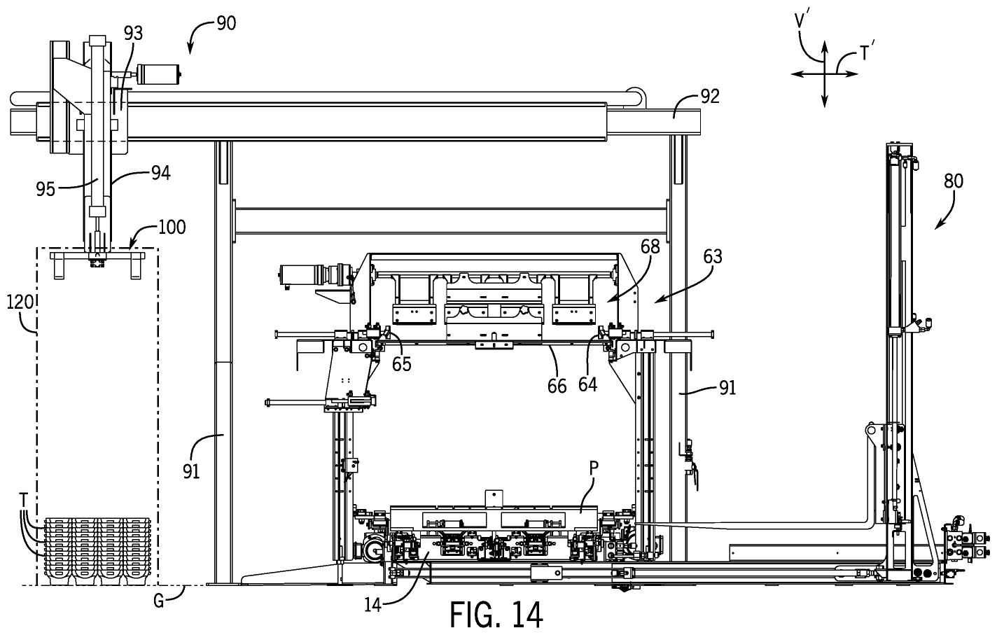

Referring now to FIG. 14, an example gantry arm machine 90 at the loading area 68 of the receiving, staging, and loading system 60 (see line T-T on FIG. 1). The gantry arm machine 90 is for placing one or more trays T onto the layers of containers C that are loaded onto a pallet P or a dolly D (as described above; note that FIGS. 14-23 depict a pallet P). In particular, as will be described in greater detail below, the gantry arm machine 90 picks up one or more trays T from a stack of trays T adjacent to the gantry arm machine 90, moves the tray(s) T into the loading area 68, and places the tray(s) T onto the pallet P or the layer of containers C (see FIGS. 13G-13H). The process of picking up and placing a tray(s) T is repeated for each layer of containers C loaded onto the pallet P (see FIG. 13H).

The gantry arm machine 90 has a support frame with vertically extending posts 91 connected to a crossbar 92 that laterally extends over the conveyor 14 and the organizing system 63. A tray carriage 93 is connected to the crossbar 92 and is slidable along the crossbar 92 into different positions (described hereinbelow). The tray carriage 93 has a first arm 94 that is moveable in the vertical direction (see arrow V) to thereby vertically move a tray actuator 95 and a lifting assembly 100. One or more actuators (not shown) move the tray carriage 93 and the first arm 94, and the actuators are controlled by the controller 200 (FIG. 1).

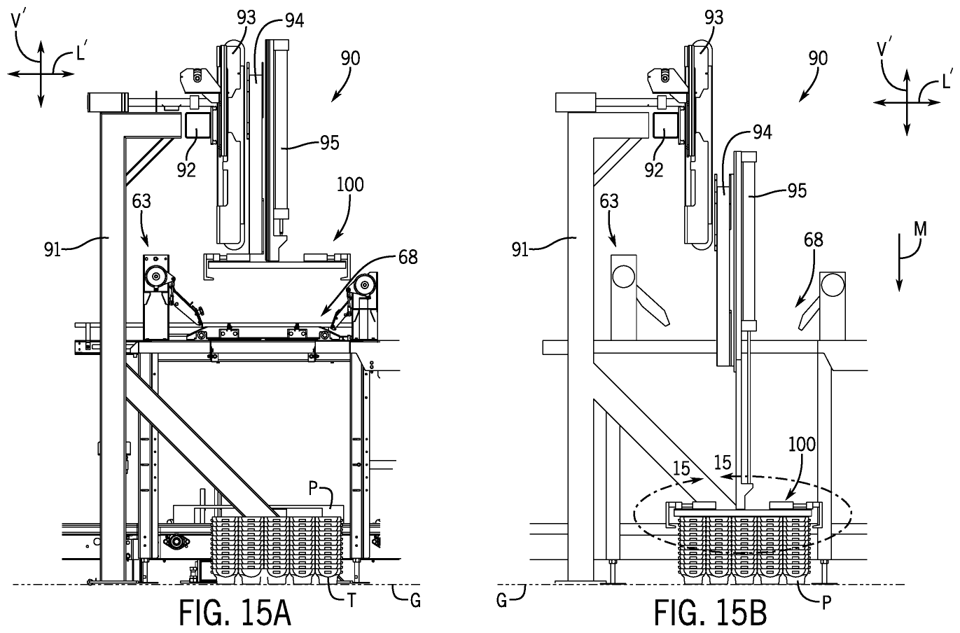

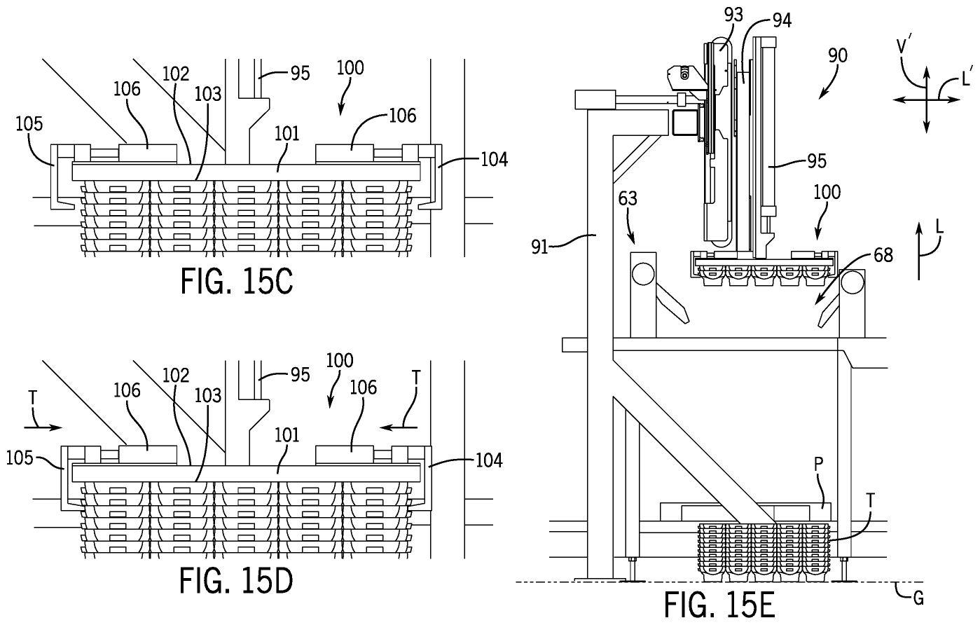

An example operational sequence of the gantry arm machine 90 for picking, moving, and placing a tray(s) T is described hereinbelow with reference to FIGS. 15A-15E and 16-23.

FIG. 15A is an end view (see line T′-T′ on FIG. 1) that depicts the tray carriage 93 in a first position vertically above the stack of trays T (see also FIG. 14). The first arm 94 is in a first position along the tray carriage 93, and the lifting assembly 100 is in a first position in which the lifting assembly 100 is vertically above the loading area 68.

FIG. 15B depicts the first arm 94 vertically downwardly moved (see arrow M) into a second position in which the first arm 94 extends from the tray carriage 93. The tray actuator 95 is also shown moved into an extended position such that the lifting assembly 100 is vertically downwardly moved into contact with the stack of trays T. Note that the first arm 94 and the lifting assembly 100 can be simultaneously or subsequently moved.

FIGS. 15C-D are enlarged views of the lifting assembly 100 in the second position in which the lifting assembly 100 contacts the top surface of the stack of trays T (see line 15-15 on FIG. 15B). The lifting assembly 100 has a frame 101 with an upper, first surface 102 and an opposite lower second surface 103. Fingers 104, 105 are coupled to the frame 101, and in this example, the fingers 104, 105 vertically extend along the frame 101 and vertically away from the second surface 103. The fingers 104, 105 are on opposite sides of the frame 101 such that the fingers 104, 105 oppose each other and are moveable toward each other. Specifically, the fingers 104, 105 are moved by finger actuators 106 which are coupled to the first surface 102 of the frame 101. The finger actuators 106 are actuated and controlled by the controller 200 (FIG. 1) such that when the lifting assembly 100 is in the second position (FIG. 15B) the fingers 104, 105 are moved toward each other (see arrow T). As such, the free ends or bottom edge of the fingers 104, 105 slide between two trays T and two trays T are clamped between the fingers 104, 105. A person of ordinary skill in the art will recognize that the fingers 104, 105 may clamp any number of trays T therebetween (e.g., 1 tray, 3 trays, 4 trays). A person of ordinary skill in the art will also recognize that multiple sets of opposing fingers 104, 105 can be included with the lifting assembly 100.

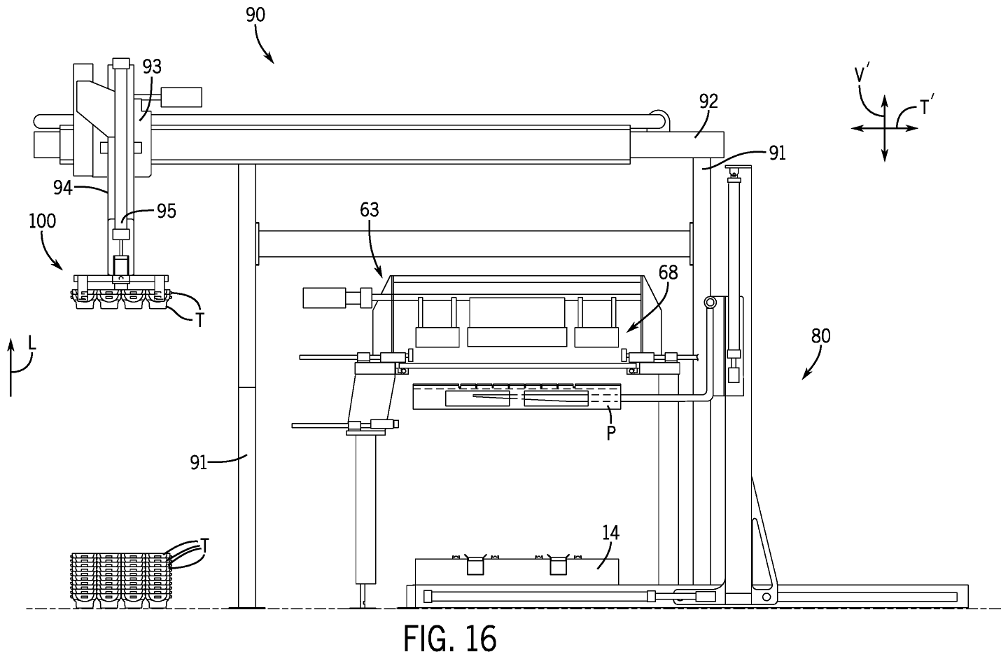

FIGS. 15E and 16 depict the first arm 94 vertically upwardly moved (see arrow L) back to the first position (FIG. 15A) and the lifting assembly 100 also vertically upwardly moved back to the first position (FIG. 15A) such that the trays T clamped between the fingers 104, 105 are vertically upwardly moved off of the stack of trays T (see arrow L). As the trays T are vertically upwardly moved, the fingers 104, 105 retain the trays T next to the frame 101. Referring specifically to FIG. 16, the forks 86 of the carriage 85 are shown lifting the pallet P into the loading area 68 and into a position vertically below the slip sheet 66 such that the trays T and a layer of containers C can be loaded onto the pallet P (as described above).

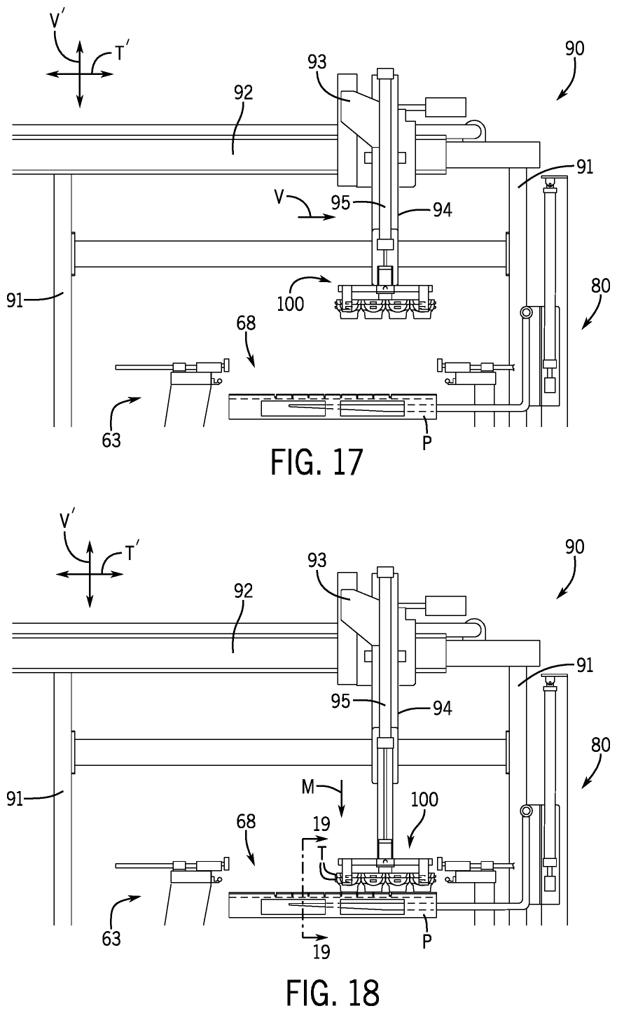

FIG. 17 depicts the tray carriage 93 moved in a first lateral direction (see arrow V) such that the tray carriage 93 and the lifting assembly 100 are vertically above the pallet P. Referring now to FIG. 18, once the lifting assembly 100 is vertically above the pallet P, the tray actuator 95 vertically downwardly moves (see arrow M) the lifting assembly 100 such that the trays T are adjacent to or contacting the pallet P.

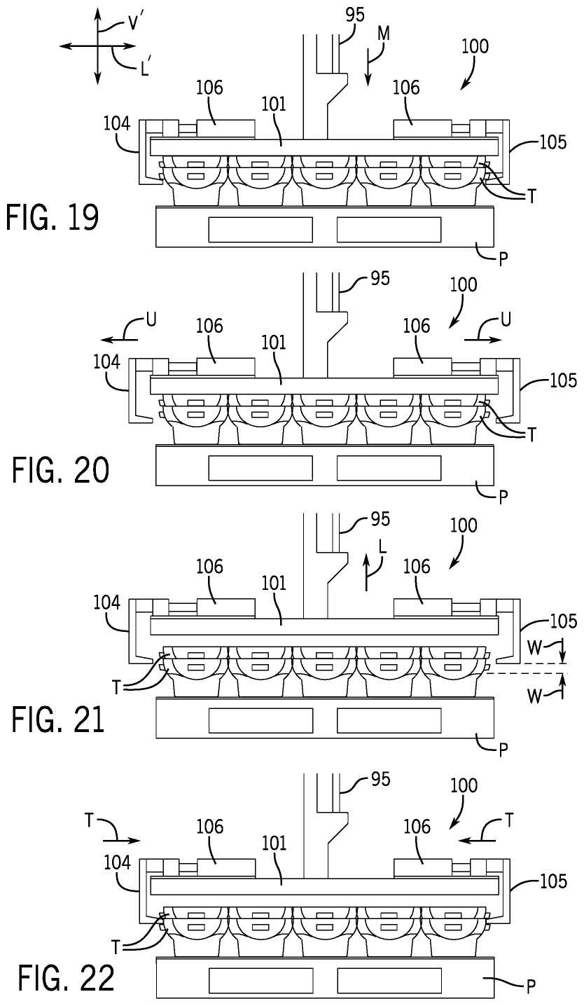

FIGS. 19-23 depict an example operational sequence of placing/releasing each of the trays T retained by the lifting assembly 100 onto the pallet P. FIGS. 19-23 are enlarged views of the trays T and lifting assembly 100 generally along line 19-19 on FIG. 18.

FIG. 19 depicts the lifting assembly 100 adjacent to the pallet P such one of the trays T (e.g., the lowermost tray T) is on or adjacent to the pallet P. The trays T are still clamped between the fingers 104, 105.

FIG. 20 depicts the fingers 104, 105 moved in a second direction (see arrows U) away from each other by the finger actuators 106 such that the trays T are no longer clamped between the fingers 104, 105. As such, the trays T rest on the pallet P.

FIG. 21 depicts the lifting assembly 100 vertically upwardly moved (see arrow L) such that the bottom edge of each finger 104, 105 is aligned between the trays T. That is, the tray actuator 95 vertically upwardly moves the lifting assembly 100 such that the bottom edge of each finger 104, 105 are aligned with a space between the two trays T. Note that distance W is the vertical distance the bottom edge of the fingers 104, 105 is vertically upwardly moved such that the bottom edge of the fingers 104, 105 is aligned with the space between the two trays T.

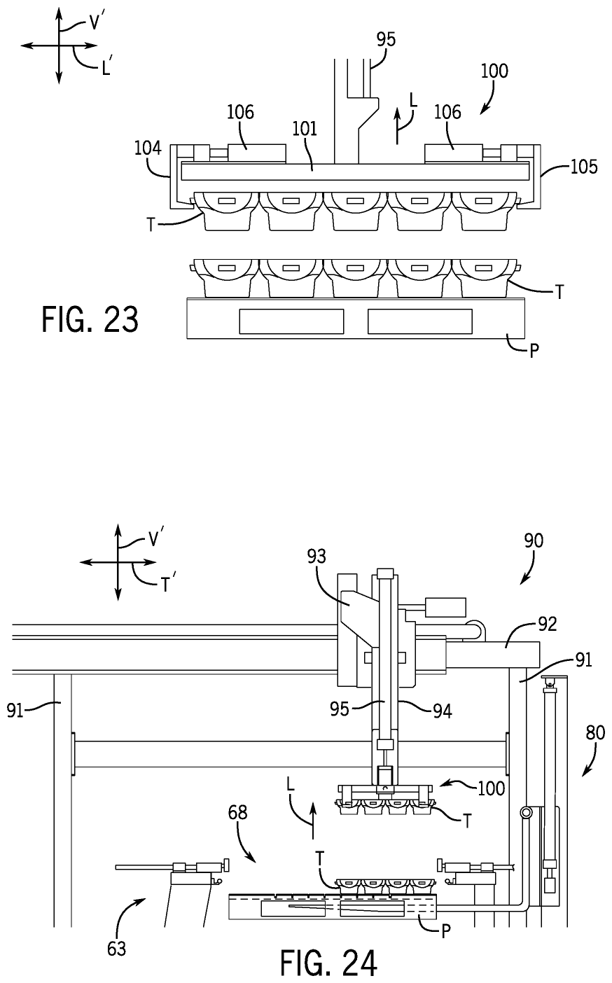

FIG. 22 depicts the fingers 104, 105 moved in the first direction toward each other (see arrow T) by the finger actuators 106 such that the bottom edge of the fingers 104, 105 is between the trays T and only one of the trays T is clamped between the fingers 104, 105. Accordingly, as depicted in FIG. 23, as the lifting assembly 100 is vertically moved away from the pallet P (see arrows L on FIGS. 23-24), one of the trays T remains on the pallet P and the other tray T is clamped between the fingers 104, 105.

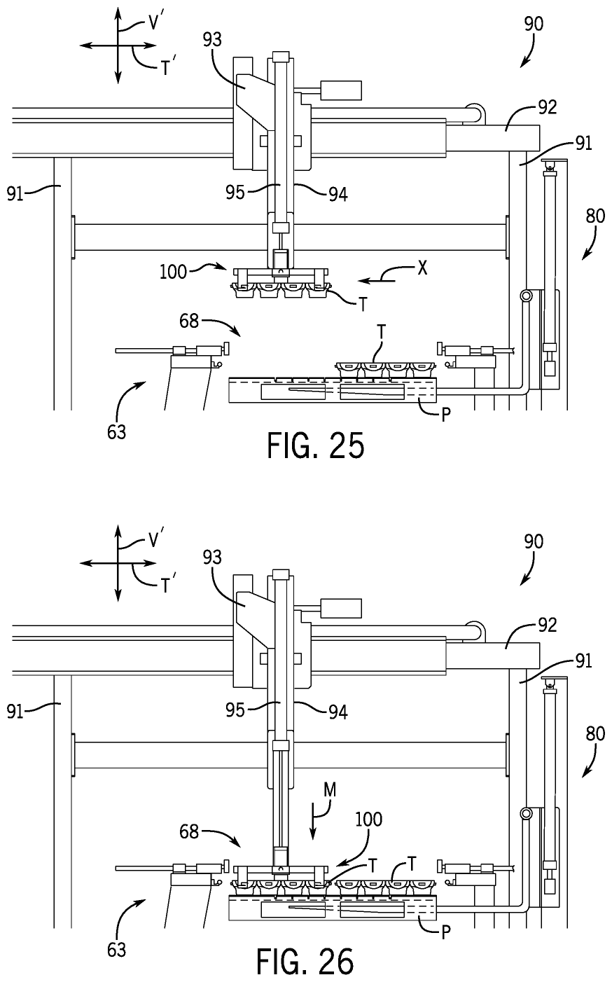

Referring now to FIG. 25, the tray carriage 93 is depicted moved in a second lateral direction (see arrow X) such that the tray carriage 93 is vertically above the pallet P and laterally offset from the tray T that is on the pallet P.

FIG. 26 depicts the lifting assembly 100 vertically downwardly moved (arrow M) toward the pallet P such that the remaining tray T clamped between the fingers 104, 105 can be placed onto the pallet P in a similar sequence as described above.

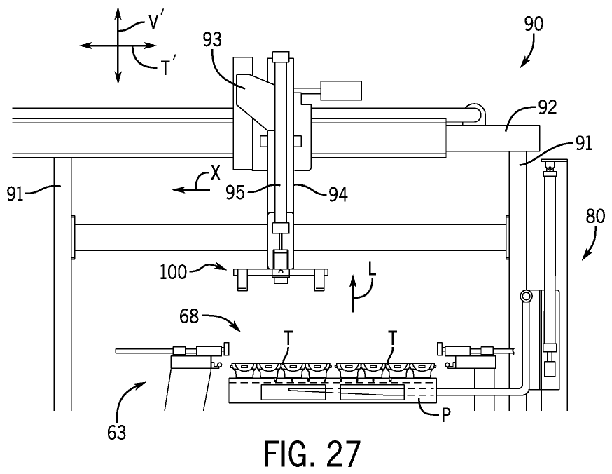

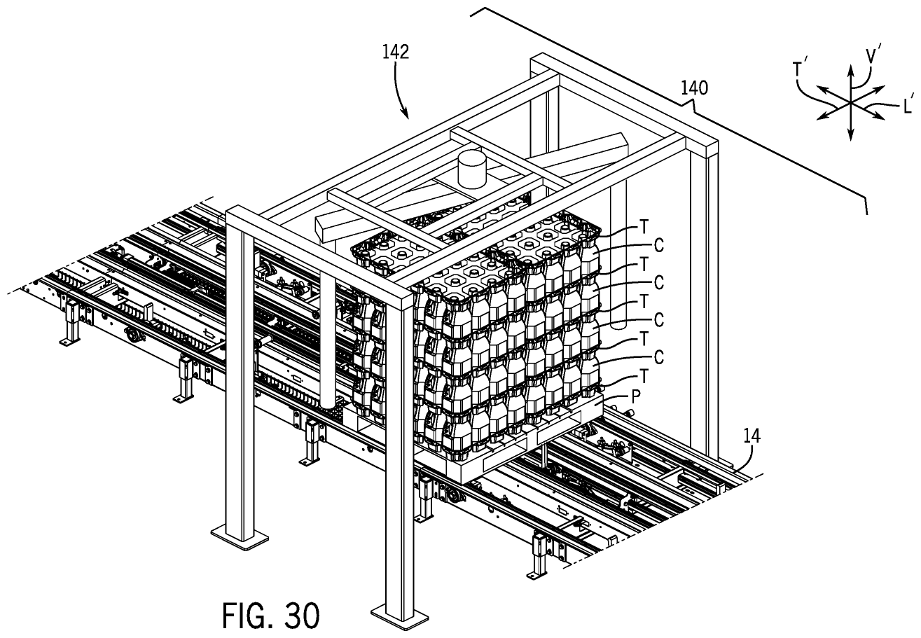

Referring now to FIG. 27, once the second tray T is placed onto the pallet P, the lifting assembly 100 is once again vertically upwardly moved away from (see arrow L) the pallet P and the tray carriage 93 is moved back to the first position as shown in FIG. 16. Accordingly, the operational sequence discussed above can be repeated to thereby place additional trays T onto the layers of containers C loaded onto the pallet P (see FIGS. 13H and 30 which depict a pallet P loaded with alternating layers of containers C and trays T).

A person of ordinary skill in the art will recognize that the above described operational sequence for picking and placing trays T can be modified based on the size and shape of the pallet P or dolly D that is loaded with containers C. For example, a single tray T may be picked up and placed onto a dolly D. In still other examples, the trays T are enlarged such that only a single, enlarged tray is necessary for placement onto a layer of containers on a pallet P. In still further examples, a first tray T is picked up and placed onto a first portion of the pallet P or layer of containers C and a second tray T is subsequently picked up and placed onto a second portion of the pallet P or layer of containers C.

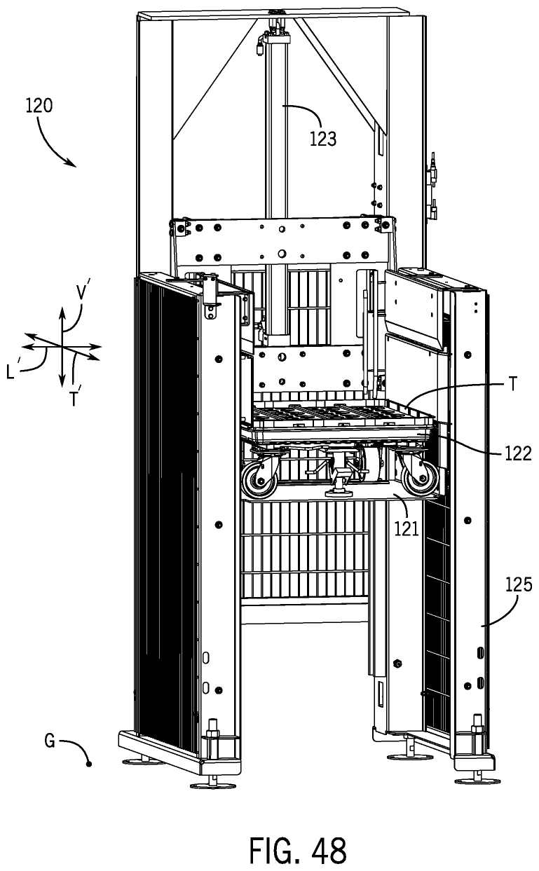

Referring to FIG. 48, an example of an optional tray dispenser 120 is depicted. The tray dispenser 120 is positioned next to the gantry arm machine 90 (see FIG. 14 with the tray dispenser 120 shown as a dashed box), and the tray dispenser 120 is configured to receive a stack of trays T and vertically lift the stack of trays T each time a tray T is removed by the gantry arm machine 90 to thereby maintain the top tray T in the stack of trays T at a predetermined tray height. The tray dispenser 120 has a frame 125 and a platform 121 onto which the stack of trays T are loaded (note that a single tray T is shown in FIG. 48 and the tray T is on a tray cart 122). In operation, the stack of trays are loaded onto the platform 121 and an actuator 123, which is connected to the controller 200 (FIG. 1), vertically moves the platform 121 such that the uppermost tray T in the stack of trays T is at the predetermined tray height. Once the uppermost tray T (or the two uppermost trays T) is removed, as described above, the actuator 123 incrementally vertically upwardly moves the platform 121 such that the uppermost tray T in the stack of trays T is at the predetermined tray height. The actuator 123 incrementally vertically moves the platform 121 each time the uppermost tray(s) T is removed. In certain examples, inclusion of the tray dispenser 120 with the system 10 allows the vertical movement of the first arm 94 and/or the tray actuator 95 that move the lifting assembly 100 toward the trays T to be shortened or eliminated from the operational sequence detailed above because the tray dispenser 120 automatically vertically moves the trays T to the predetermined tray height and toward the lifting assembly 100. As such, speed of tray placement and operation of the gantry arm machine 90 increases.

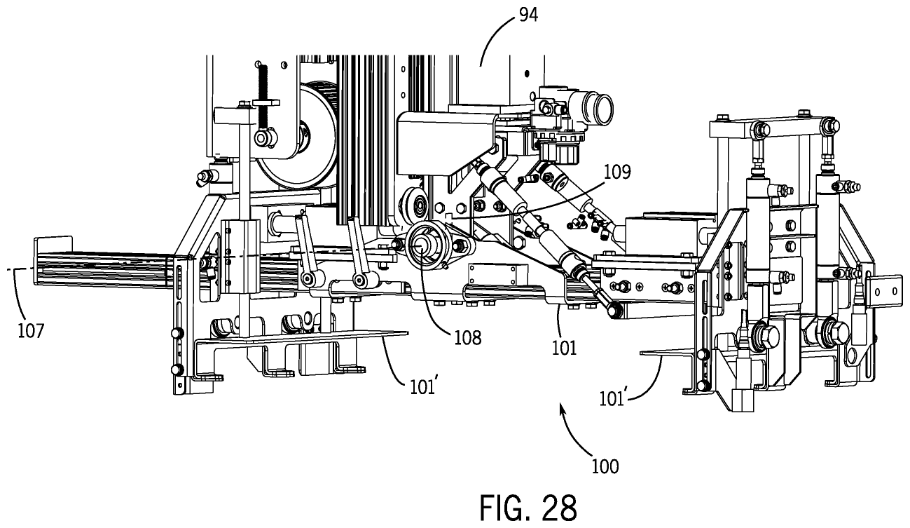

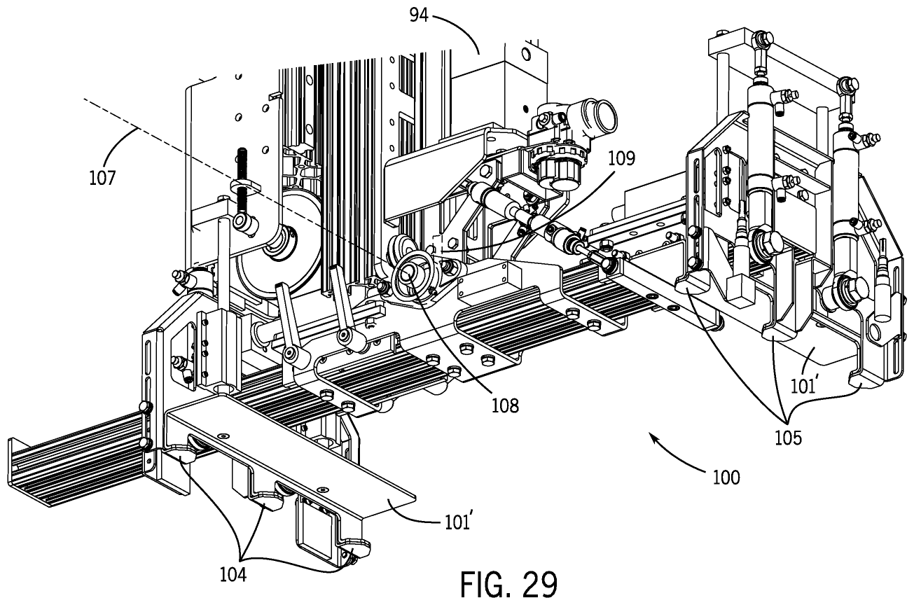

Referring to FIGS. 28-29, the present inventors have recognized that the orientation of the top surface of the stack of trays T (see FIG. 16) relative to a horizontal plane can be inconsistent each time a tray T is removed. For example, after two trays T are removed (as described above) the top surface of the stack of trays T may be slightly tilted relative to the horizontal plane. As such, the present inventors have developed the below-described features of the lifting assembly 100 to account for different orientations of the top surface of the stack of trays T relative to the horizontal plane such that the correct number of trays T can be consistently removed from the stack of trays T.

The lifting assembly 100 depicted in FIGS. 28-29 is pivotally coupled to the first arm 94 at a pivot axis 107 by a pivot pin 108. As the lifting assembly 100 contacts the top surface of the stack of the trays T (see also FIG. 14), the frame 101 pivots about the pivot axis 107 to thereby align the frame 101 to the top surface of the stack of trays T. As such, the fingers 104, 105 can be properly inserted into the stack of trays T to thereby clamp the correct number of trays T there between. Note that in the example depicted in FIGS. 28-29, the frame 101 includes lower frame members 101′ which contact the top surface of the stack of trays T. The first arm 94 also includes a channel 109 (see dashed lines) in which the pivot pin 108 moves as the frame 101 pivots. The movement of the pivot pin 108 in the channel 109 prevents the lifting assembly 100 from applying too much force on the stack of trays T. As such, the lifting assembly 100 does not crush the trays T. The shape of the channel 109 can vary (e.g., linear, curved). In certain examples, air cylinders are coupled to the frame 101 and are configured to be actuated by an air system (not shown) which is controlled by the controller 200 (FIG. 1) to thereby pivot the frame 101.

Packaging Section

FIG. 30 depicts a pallet P loaded with layers of containers C and trays T conveyed from the loading system 60 (see FIG. 1; described above) by the conveyor 14 (see also FIG. 13H) to the packaging section 140. The packaging section 140 further processes the pallet P loaded with layers of containers C. For example, the packaging section 140 has a shrinkwrap machine 142 that extends over the conveyor 14 that applies (e.g., wraps) plastic shrinkwrap around the pallet P and the containers C to increase the stability of the loaded pallet P or dolly D. In certain examples, the shrinkwrap machine 142 advantageously applies the plastic shrinkwrap onto the side surfaces of the pallet P and the containers C. An example conventional shrinkwrap machine 142 is manufactured by Wulftec (model # WCRT0200). The packaging section 140 can include other machines or components for processing the pallet P and/or the containers C (e.g., cleaning devices, cooling or freezing machines, drying machines, sanitizing machines).

Lift Device

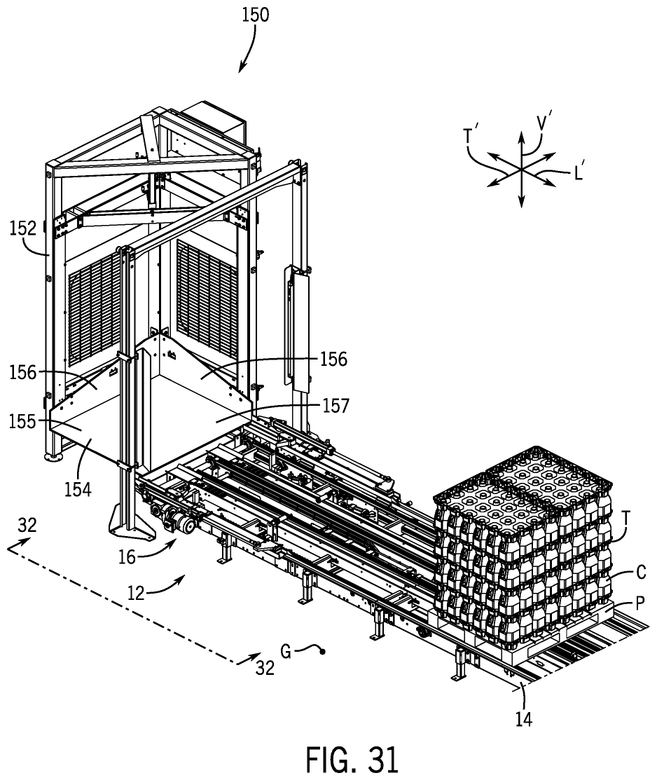

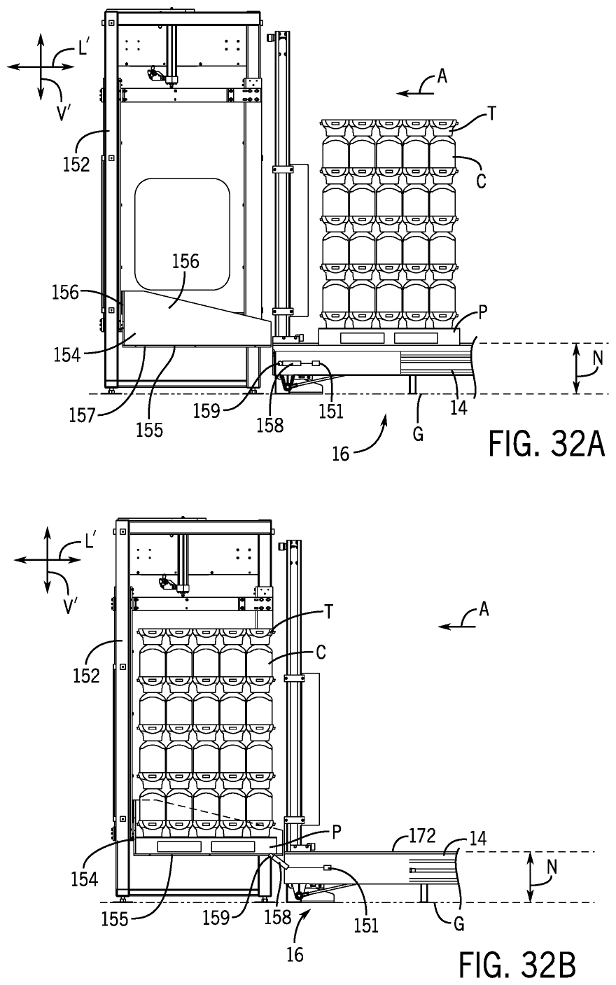

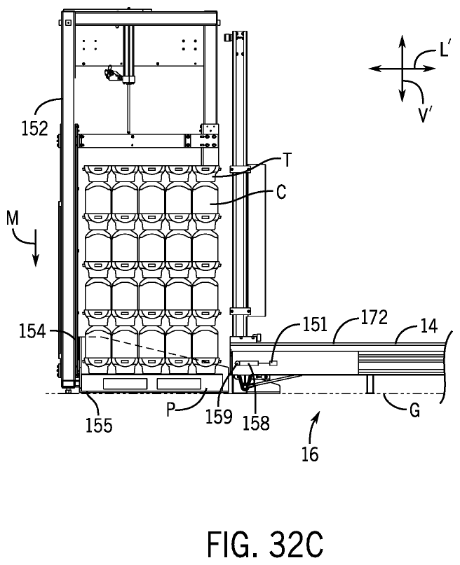

FIG. 31 depicts an example lift device 150 for lowering the pallet P or the dolly D loaded with containers C off of the conveyor 14 and onto the ground G. The lift device 150 is at the downstream end 12 of the system 10 and at the end 16 of the conveyor 14. Note that FIG. 31 depicts a pallet P loaded with containers C, however, a dolly D could be substituted for the pallet P. The lift device 150 has a frame 152 and a support member 154 onto which the pallet P is conveyed from the conveyor 14 (see FIG. 32C). The support member 154 vertically slides along the frame 152 to thereby receive and vertically lower the pallet P loaded with containers C onto the ground G. The size and shape of the support member 154 can vary, and in the example depicted the support member 154 comprises a horizontal rectangular plate 155 and a pair of sidewalls 156 vertically extending from the plate 155. A support arm 158 is also included to selectively vertically support the underside of the rectangular plate 155 opposite the sidewalls 156 to thereby prevent damage (e.g., bending) of the rectangular plate 155 when the weight of the loaded pallet P is on the rectangular plate 155. The support arm 158 has a roller 159 and an actuator 151, which is connected to the controller 200 (FIG. 1). Operation of the support arm 158 is described herein below. In the example depicted, the support arm 158 is on the conveyor 14. In other examples, the support arm 158 is on the ground G or on the frame 152.

An example operational sequence for vertically lowering the pallet P loaded with containers C off the conveyor 14 and onto the ground G is described hereinbelow with respect to FIGS. 32A-32C, which are side views of the lift device 150 shown in FIG. 31 (see line 32-32 on FIG. 31).

FIG. 32A depicts the pallet P loaded with containers C conveyed to the downstream end 16 of the conveyor 14 and adjacent to the lift device 150. The support member 154 is in a first position in which the rectangular plate 155 is substantially at the same vertical elevation as the top surface 172 of the conveyor 14. The distance between the ground G and the support surface 157 is shown by arrow N. The support arm 158 is in a retracted position.

FIG. 32B depicts the pallet P conveyed onto the support surface 157 by the conveyor 14 (see arrow A). Prior to the pallet P being conveyed onto the support surface 157, the actuator 151 moves the roller 159 of the support arm 158 into contact with the underside of the rectangular plate 155. The actuator 151 is pivotally connected to the conveyor 14 and the support arm 158 is guided by a track (not shown) such that the roller 159 contacts the rectangular plate 155. As such, the support arm 158 prevents the rectangular plate 155 from bending as the pallet P is moved onto the support surface 157. After the pallet P is on the support surface 157, as shown in FIG. 32C, the support member 154 is vertically downwardly moved (see arrow M) to a second position in which the pallet P can be laterally manually moved off the support member 154 and onto the ground G. As the support member 154 is moved, the support arm 158 is slowly moved back to the retracted position by the actuator 151 such that the support arm 158 supports the support member 154 as it is moved. In other examples, a forklift (not shown) can be used to move the pallet P off the support member 154. After the pallet P is moved off the support member 154, the support member 154 is moved back to the first position (FIG. 31A) so that another pallet P can be conveyed onto the support member 154. In certain examples, the lift device 150 advantageously permits dollies D loaded with containers C to be manually moved (e.g. wheeled) off of the conveyor 14 without of the use of heavy machinery (e.g. forklift).

In certain examples, an actuator (not shown) is coupled to the frame 152 and the support member 154 and is for vertically moving (e.g. lowering and raising) the support member 154 along the frame 152 relative to the conveyor 14. The actuator is controlled by the controller 200 (FIG. 1). That is, the actuator moves the support member 154 into and between the first and second positions (as described above). The controller 200 controls the actuator based on a program stored on the memory 202, signals from switches and/or sensors (not shown). In some instances, limit switches send signals to the controller 200 when the pallet P moves past the limit switches, proximity sensors sense the location of the pallet P relative to the conveyor 14 and send corresponding signals to the controller 200, and load sensors sense when the pallet P is on the support member 154.

In another example, the support member 154 is movable by gravity from the first position (FIG. 32A) to the second position (FIG. 32C) when the pallet P is conveyed onto the support member 154. The support member 154 is also biased to the first position (FIG. 32A) by a biasing device (e.g., spring) (not shown) such that after the pallet P is laterally moved off the support member 154, the support member 154 automatically moves from the second position (FIG. 32C) to the first position (FIG. 32A). The biasing device may include components for slowing the speed at which the support member 154 moves into and the between the first position (FIG. 32A) and the second position (FIG. 32C) and/or components that prevent the support member 154 from moving until the pallet P is completely on the support member 154.

Conveyor

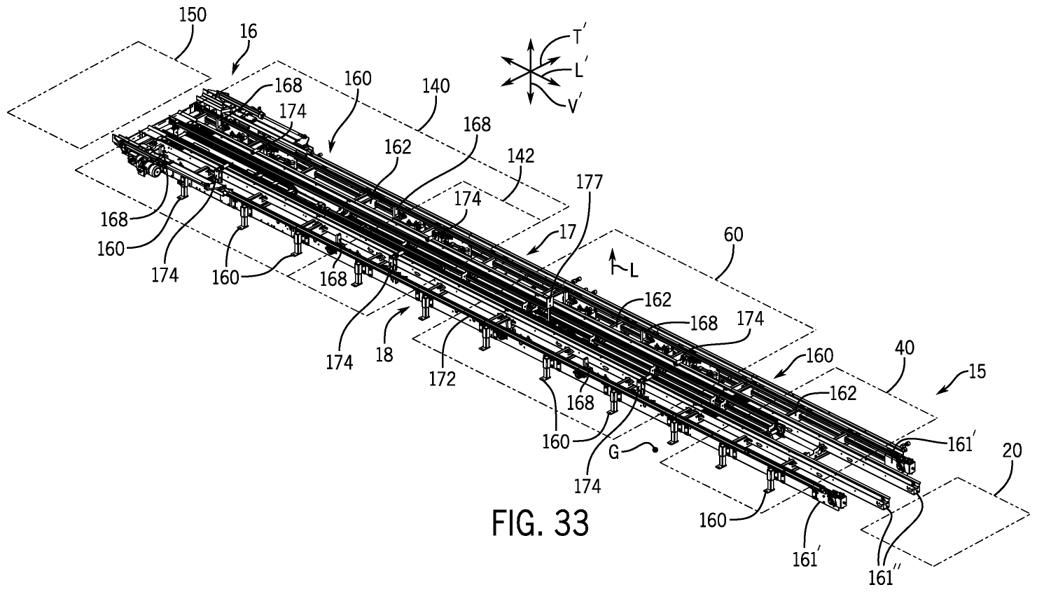

FIG. 33 depicts the conveyor 14 shown in FIG. 1 in greater detail. The conveyor 14 has a first lateral side 17 and an opposite second lateral side 18. For purposes of clarity, the dolly dispenser 20, the pallet dispenser 40, the loading system 60, the packaging section 140, the shrinkwrap machine 142, and the lift device 150 are shown in dashed lines relative to each other and the conveyor 14.

The conveyor 14 has a plurality of legs 160 that vertically support longitudinal framing members 161′, 161″ that extend in the longitudinal direction (arrow L) and lateral framing members 162 that extend in the lateral direction (arrow T) above the ground G. The longitudinal framing members 161′, 161″ are parallel to each other.

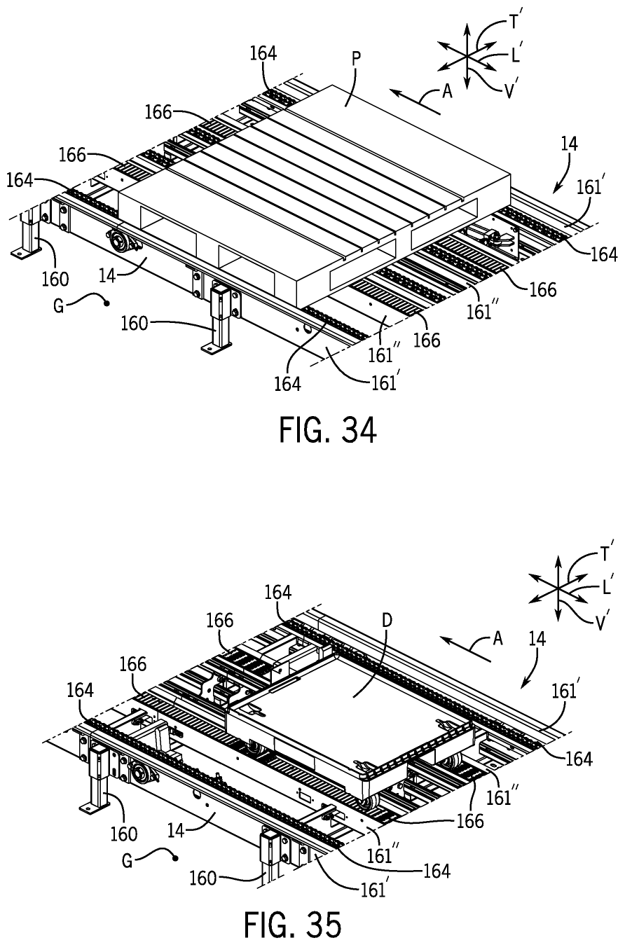

Referring now to FIG. 34, the conveyor 14 has a pair of first conveyance devices 164 (e.g., continuous chains) that extend along the lateral-most or outside longitudinal framing members 161′. The first conveyance devices 164 are each circulated in a continuous loop along one of the longitudinal framing members 161′ by an actuator (not shown, e.g. a motor with a sprocket) such that pallets P dispensed onto the conveyor 14 (see above FIGS. 5 and 64A-6B) ride on the first conveyance devices 164 and are therefore conveyed downstream to different sections in the system 10. Specifically, the lower surface of the pallet P contacts the top surface of the first conveyance devices 164. The actuator is controlled by the controller 200 (FIG. 1).

Referring now to FIG. 35, the conveyor 14 has a pair second conveyance devices 166 (e.g., continuous belt) that extend along the inside longitudinal framing members 161″ that are laterally inset from the lateral-most longitudinal framing members 161′. The second conveyance devices 166 are each circulated in a continuous loop along one of the longitudinal framing members 161″ by an actuator (not shown, e.g. a motor) such that dollies D dispensed onto the conveyor 14 (see above FIGS. 2-3 and 4A-4F) ride on the second conveyance devices 166 and are conveyed downstream to different positions in the system 10. Specifically, the wheels E2 of the dolly D contact the top surface of the second conveyance devices 166. The actuator is controlled by the controller 200 (FIG. 1).

The second conveyance devices 166 are vertically downwardly offset relative to the first conveyance devices 164 (e.g., the top surfaces of the second conveyance devices 166 are vertically lower than the top surfaces of the first conveyance devices 164) such that the pallets P on the first conveyance devices 164 do not contact and are not influenced by the second conveyance devices 166. The positioning of the first conveyance devices 164 relative to the second conveyance devices 166 on the conveyor 14 can vary, however, the present inventors have found that it is advantageous to position the second conveyance devices 166 laterally inwardly relative to the first conveyance devices 164 as commonly used pallets P are typically laterally wider than commonly used dollies D. The type of conveyance devices 164, 166 can vary (e.g., chains, ratchet conveyor system, belts).

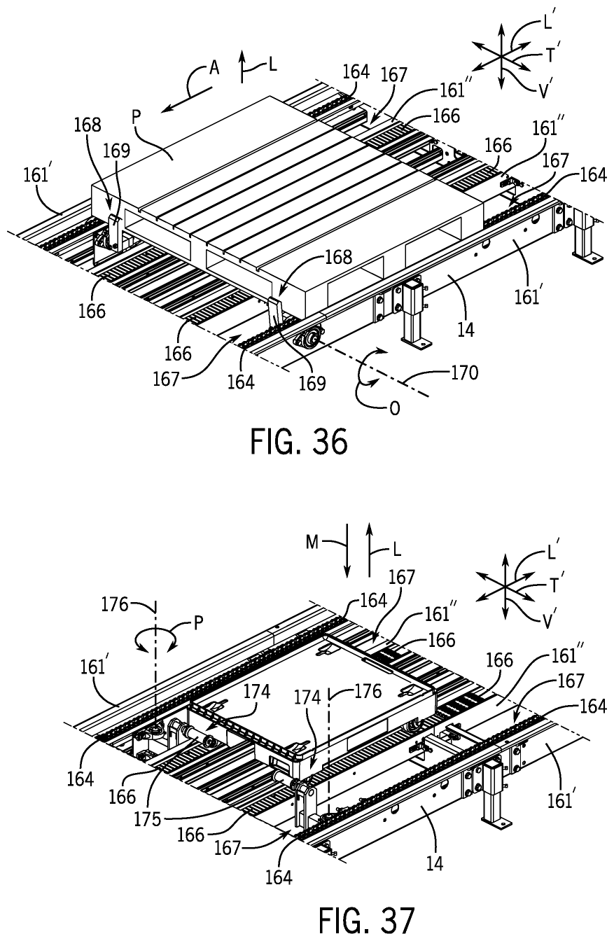

Referring now to FIGS. 36-37, the conveyor 14 has one or more stop devices, namely pallet stops 168 and/or dolly stops 174, that are configured to stop the pallet P or dolly D at different positions along the conveyor 14. For example, the stops 168, 174 are positioned at the loading system 60 (see FIG. 33) to thereby stop the pallet P or the dolly D before the pallet P or dolly D reaches the loading system 60. FIG. 33 depicts the stops 168, 174 spaced apart from each other for clarity, however, the stops 168, 174 can be aligned or immediately adjacent to each other. The number and position of the stops 168, 174 can vary. In one example, the stops 168, 174 stop pallets P or dollies D, respectively, from being conveyed to the lift apparatus 80 when a pallet P or dolly D is being lifted by the forks 86 (see FIG. 13E). In another example, the stops 168, 174 stop pallets P or dollies D, respectively, from being conveyed to the lift device 150.

FIG. 36 depicts a pallet P stopped on the conveyor 14 by a pair of pallet stops 168. Each pallet stop 168 is coupled to one of the longitudinal framing members 161′, 161″ and is pivotable into and between a first or up position in which stop members 169 vertically upwardly extend (see arrow L) above the first conveyance devices 164 to thereby stop conveyance of the pallet P and a second or down position (not shown) in which the stop members 169 are vertically below the first conveyance devices 164 in a channel 167 between the longitudinal framing members 161′, 161″ such that the pallet P can be freely conveyed by the conveyor 14. The stop member 169 is pivoted by an actuator (not shown) that is controlled by the controller 200. In particular, the stop member 169 is pivoted about pivot axis 170 (see arrow O).

FIG. 37 depicts a dolly D stopped on the conveyor 14 by a pair of dolly stops 174. Like the pallet stops 168 (FIG. 36) noted above, each dolly stop 174 is coupled to one of the longitudinal framing members 161′, 161″ and is pivotable into and between a first or up position in which stop members 175 vertically upwardly extend (see arrow L) above the second conveyance devices 166 to thereby stop conveyance of the dolly D by the conveyor 14 and a second or down position (not shown) in which the stop members 175 are vertically below the second conveyance devices 166 in the channel 167 such that the dolly D can be freely conveyed by the conveyor 14. The stop member 175 is pivoted by an actuator (not shown) that is controlled by the controller 200 (FIG. 1). In particular, the stop member 175 is pivoted about a pivot axis 176 (arrow P). As the stop member 175 pivots, the stop member 175 automatically vertically downwardly articulates (see arrow M) such that the stop member 175 is fully in the channel 167. Accordingly, the stop member 175 does not obstruct pallets P conveyed on the conveyor 14.

Referring back to FIG. 33, a paddle 177 is included with conveyor 14 and is for stopping the pallet P or the dolly D. The paddle 177 is coupled to one of the longitudinal framing members 161′, 161″ and pivotable into and between a first or up position in which the paddle 177 vertically upwardly extends (see arrow L) away from the conveyor 14 and a second and a second or down position (not shown) in which the paddle 177 is in one of the channels 167 (see FIG. 36).

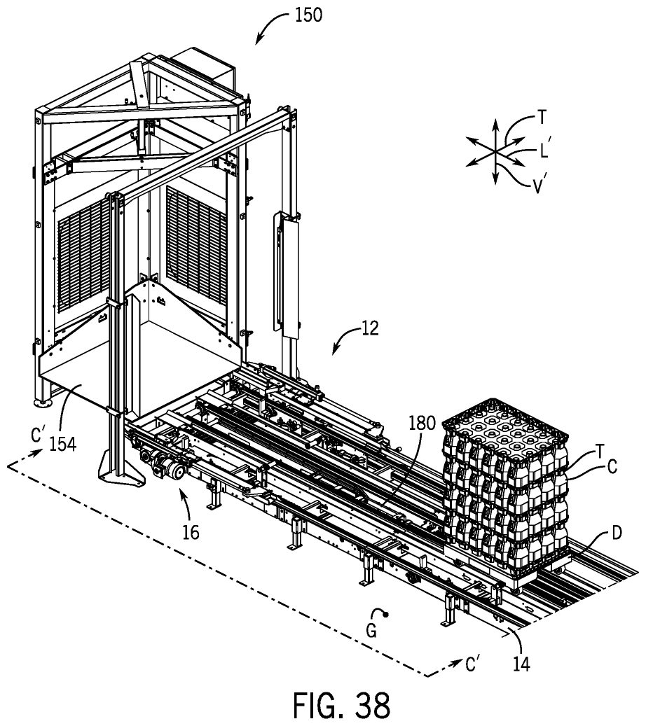

Referring now to FIGS. 38-43, the present inventors have recognized that the dolly D loaded with containers C may not be conveyed completely off the conveyor 14 and onto the support member 154 of the lift device 150. As such, the dolly D may become stuck at the downstream end 16 of the conveyor 14. Accordingly, the present inventors have determined that is advantageous to include a pusher device, namely a dolly pusher 180, that contacts and pushes the dolly D off the conveyor 14 and onto the support member 154 of the lift device 150.

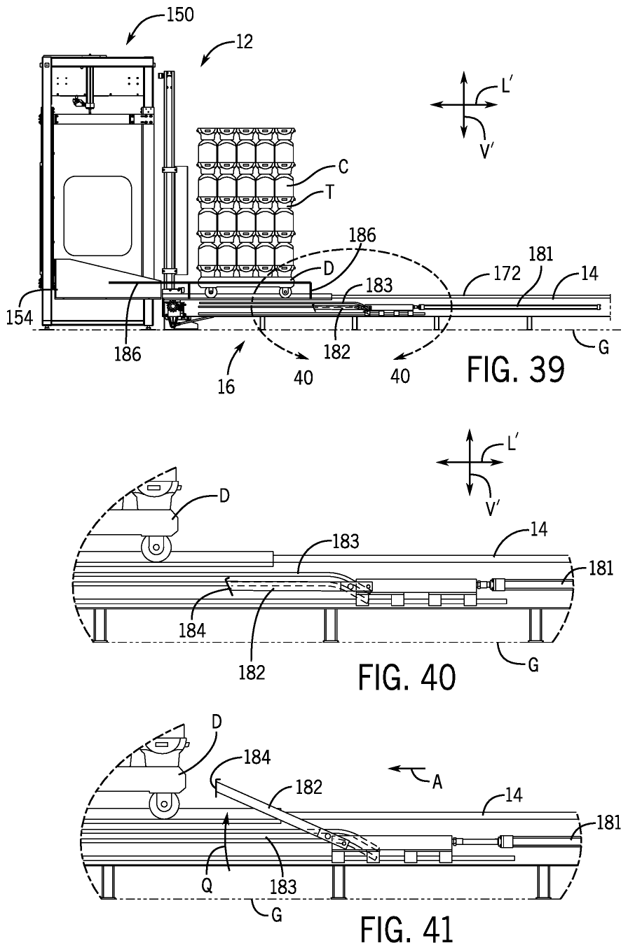

FIG. 39 is a side view at the downstream end 16 of the conveyor 14 (see FIG. 38 generally at line C′-C′). The dolly D is at the downstream end 16 of the conveyor 14 and the dolly pusher 180 is in a retracted position (see also FIG. 40 which is an enlarged view within line 40-40 on FIG. 39). Guide bars 186 extend in the longitudinal direction on either side of the dolly D to thereby guide the dolly D as it is moved in the longitudinal direction. The guide bars 186 are connected to the conveyor 14, and in certain examples, the guide bars 186 a connected to a movable bracket 193 of an ejector 190 (described hereinbelow).

FIG. 41 depicts an actuator 181, which is controlled by the controller 200 (FIG. 1), for moving the dolly pusher 180 in the first direction (see arrow A). The dolly pusher 180 has an arm 182 that slides along a curved track 183 and automatically vertically upwardly moves (e.g., pivots) (see arrow Q) as the actuator 181 moves the dolly pusher 180. As such, the arm 182 is in an extended position and the end 184 of the arm 182 is vertically above the top of the conveyor 14.

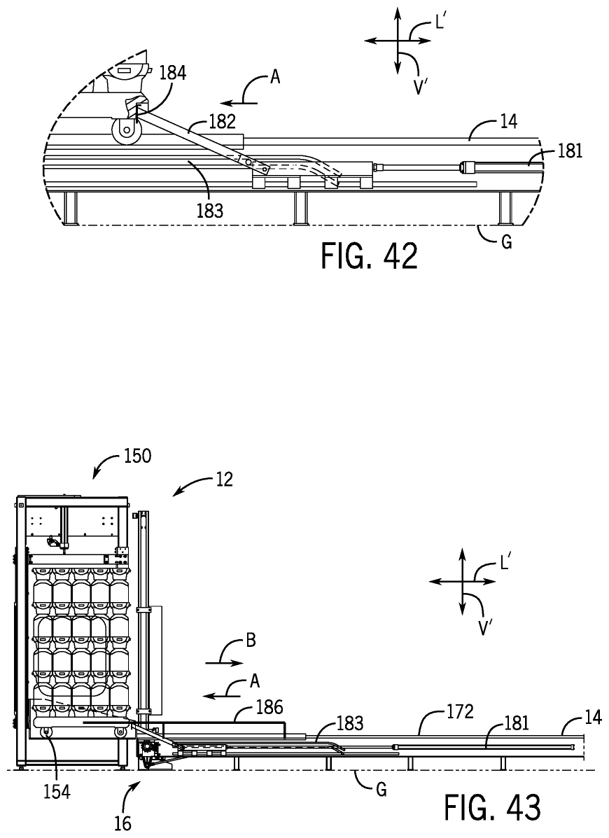

Referring to FIG. 42, as the actuator 181 continues to actuate, the arm 182 is moved in the first direction (arrow A) such that the end 184 contacts the dolly D and pushes (see arrow A) the dolly D off the conveyor 14 and onto the support member 154, as shown in FIG. 43. To move the arm 182 back to the retracted position (FIG. 40), the actuator 181 moves the arm 182 in the second direction (see arrow B). As such, the arm 182 moves along the curved track 183 and automatically vertically moves (e.g., pivots) below the top surface 172 of the conveyor 14 (FIG. 39).

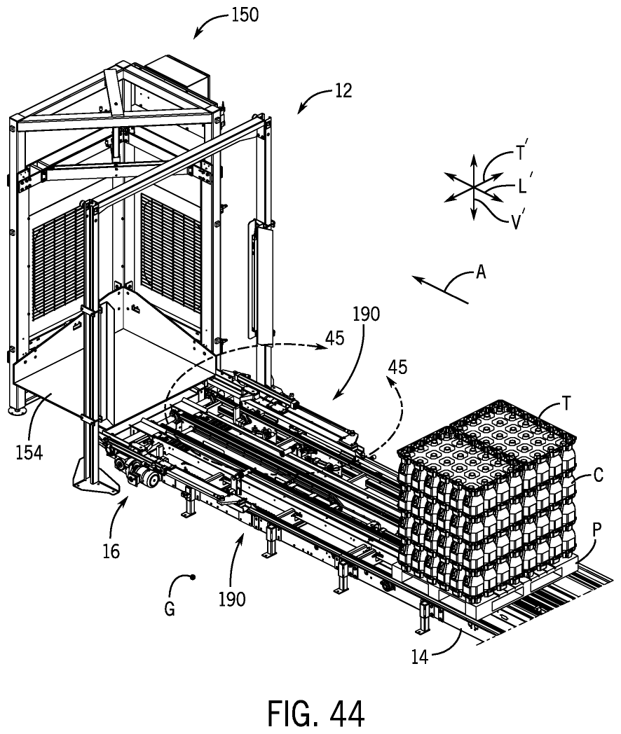

Referring to FIG. 44, the conveyor 14 has an ejector 190 for pushing a pallet P loaded with containers C onto the support member 154. FIG. 44 depicts a pallet P fully loaded with containers C on the conveyor 14 and conveying in the first direction (see arrow A). An ejector 190 is positioned on each lateral side of the conveyor 14.

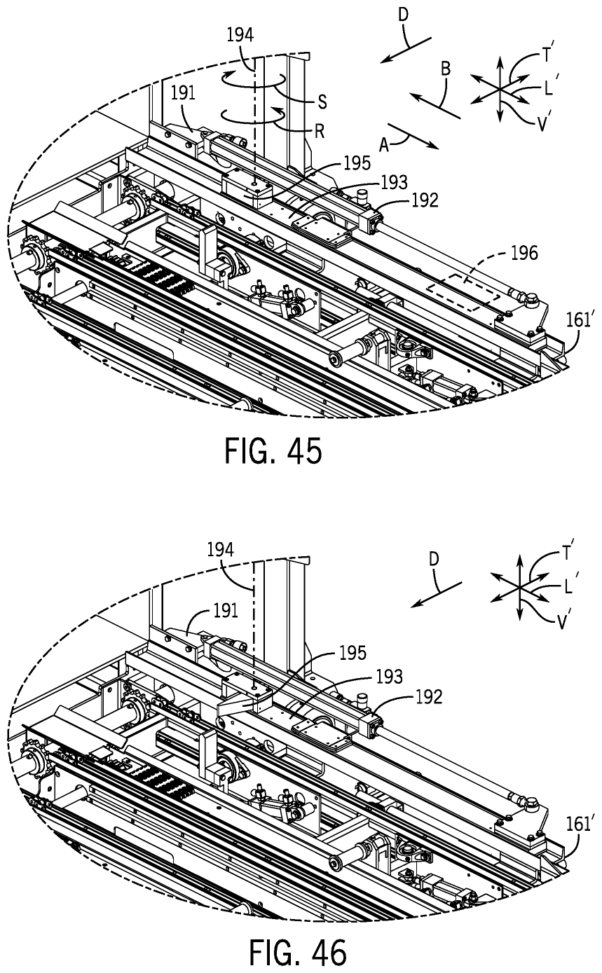

FIG. 45 depicts one of the ejectors 190 in greater detail (FIG. 45 is an enlarged view within line 45-45 on FIG. 44). The ejector 190 has a stationary frame 191 that is coupled to the longitudinal framing members 161′. An actuator 192 is connected to the frame 191, and a movable bracket 193 is slidable along the frame 191 into and between a first position (FIG. 45) and a second position (see dashed box 196 on FIG. 45). The bracket 193 has a pivotable finger member 195 that pivots into and between a first position (FIG. 45) in which the finger member 195 extends along the frame 191 and a second position (FIG. 46) in which the finger member 195 extends laterally inwardly (see arrow D). The finger member 195 pivots about pivot axis 194 (see arrows R and S).

An example operational sequence for the ejector 190 is described hereinbelow. As shown in FIG. 45, the bracket 193 is in the first position and the finger member 195 is in the first position. As such, the pallet P can be conveyed in the first direction (see arrow A) by the conveyor 14 to the downstream end 16 of the conveyor 14 (as seen in FIG. 44). Once the pallet P is at the downstream end 16 of the conveyor 14 and adjacent to the ejector 190, the actuator 192, which is controlled by the controller 200, moves (e.g., slides) the bracket 193 in the second direction (see arrow B) into the second position (see dashed box 196 on FIG. 45). After the bracket 193 is in the second position (see dashed box 196 on FIG. 45), an actuator (not shown) pivots the finger member 195 from the first position (see FIG. 45) to the second position (see FIG. 46).

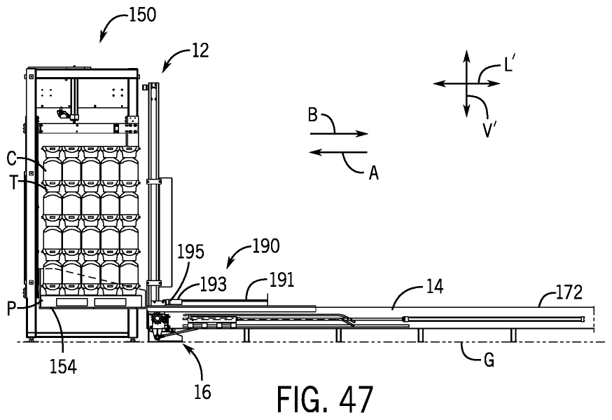

The actuator 192 then slides the bracket 193 back toward the first position (FIG. 46) such that the finger member 195 contacts and pushes the pallet P (FIG. 44) onto the support member 154 of the lift device 150 as shown in FIG. 47. FIG. 46 depicts the bracket 193 in the first position and the finger member 195 is in the second position after the pallet P has been pushed onto the support member 154. The finger member 195 is then pivoted back to the first position (FIG. 45) such that an additional pallet P can be conveyed to the downstream end 16 of the ejector 190.

The present inventors have contemplated that the components or sections of the system 10 described above can be varied to thereby fit the specific needs of each facility in which the system 10 is installed. That is, different components or sections of the system 10 may be included or excluded based on the specific application of the system 10 in the facility. For example, another system 10 receives and loads only pallets P. Accordingly, the dolly dispenser 20 is excluded from the system 10. Furthermore, the system 10 can be retrofitted after the initial installation as the operations in the facility change. Still further, the present inventors have contemplated that various methods of operation of the system 10 may be implemented based on the operational sequences noted herein.

Selection of a pallet P or a dolly D is determined by the operator of the system 10. For instance, a first customer may require containers C be shipped to their stores on dollies D, while a second customer may require containers C be shipped to their stores on pallets P. To select whether a pallet P or dolly D will be loaded with containers C, an operator selects the pallets P or dollies D via the user input device 204 (FIG. 1). For example, if the operator selects three pallets P and two dollies D, the pallet dispenser 40 will first consecutively dispenses three pallets P onto the conveyor 14. The pallets P are then conveyed to the loading system 60 by the conveyor 14 where each pallet P is loaded with a preselected number of containers C. While the three pallets P are being conveyed and loaded, the dolly dispenser 20 consecutively dispenses two dollies D onto the conveyor 14. The dollies D are then conveyed to the loading system 60 by the conveyor 14 and loaded with a preselected number of containers C.

In certain examples, a system for loading containers onto a transport structure includes a slip sheet configured to receive the containers and having a first end and an opposite second end. The slip sheet is moveable in a first direction from a first position in which the containers are received onto the slip sheet and a second position in which the slip sheet is vertically above the transport structure, and the slip sheet is further movable in a second direction opposite the first direction to thereby move the slip sheet from the second position to the first position. A first brace member is adjacent to the second end of the slip sheet when the slip sheet is in the second position, and a second brace member is adjacent to the first end of the slip sheet when the slip sheet is in the second position wherein when the slip sheet is moved in the second direction from the second position to the first position the second brace member is configured to prevent the containers from moving in the second direction with the slip sheet such that the containers vertically fall off the slip sheet onto the transport structure. The first brace member is configured to vertically guide the containers onto the transport structure.

In certain examples, the first brace member is configured to prevent rotation of the containers such that the containers vertically fall off the slip sheet. The first brace member can be configured to pivot into contact with the containers before the slip sheet is moved in the second direction. The first brace member is elongated along the second end of the slip sheet. In certain examples, the second brace member is pivotable into and between a first position in which the second brace member is vertically above the containers on the slip sheet and a second position in which the second brace member is adjacent to the containers on the slip sheet such that when second brace member is in the first position the containers vertically pass under the second brace member as the slip sheet is moved in the first direction. The second brace member has a guide arm configured to pivot into contact with the containers and thereby guide the containers onto the transport structure as the containers fall off of the slip sheet. The second brace member and the guide arm are elongated along the first end of the slip sheet. The guide arm has a first elongated member and a second elongated member that are parallel to each other, and the first elongated member and the second elongated member are configured to guide the containers onto the transport structure. The first elongated member and the second elongated member are configured to prevent rotation of the containers such that the containers vertically fall off the slip sheet.

In certain examples, a guide member is configured to guide the containers into position on the slip sheet as the containers are received onto the slip sheet. In certain examples, before the slip sheet is moved in the first direction from the first position to the second position the guide member is vertically moved away from the slip sheet such that the containers freely move under the guide member when the slip sheet is moved in the first direction. The guide member is an elongated rod along which the containers slide.

In certain examples, a method of loading containers onto a transport structure includes receiving containers onto a slip sheet having a first end and an opposite second end and moving the slip sheet with the containers thereon in a first direction from a first position in which the containers are loaded onto the slip sheet to a second position in which the slip sheet is vertically above the transport structure. A first brace member is adjacent to the second end of the slip sheet when the slip sheet is in the second position. The method can further include moving a second brace member adjacent to the first end of the slip sheet when the slip sheet is in the second position and moving the slip sheet in a second direction opposite the first direction from the second position to the first position such that the second brace member prevents the containers from being moved with the slip sheet in the second direction and the containers fall off the slip sheet onto the transport structure. The first brace member can vertically guide the containers onto the transport structure.

In certain examples, the first brace member is configured to prevent rotation of the containers such that the containers vertically fall off the slip sheet. In certain examples, the method includes pivoting the first brace member into contact with the containers before the slip sheet is moved in the second direction from the second position to the first position. The second brace member is movable into and between a first position in which the second brace member is vertically above the containers on the slip sheet and a second position in which the second brace member is adjacent to the first end of the slip sheet and the containers when the slip sheet is in the second position. The method can further include pivoting a guide arm of the second brace member into contact with the containers to thereby vertically guide the containers onto the transport structure as the slip sheet is moved in the second direction. The guide arm has a first elongated member and a second elongated member that extend parallel to each other, and the first elongated member and the second elongated member are configured to contact the containers and vertically guide the containers onto the transport structure as the slip sheet is moved in the second direction. The first elongated member and the second elongated member are configured to prevent rotation of the containers such that the containers vertically fall off the slip sheet. In certain examples, the method includes moving a guide member vertically away from the slip sheet before the slip sheet and the containers are moved in the first direction the first position to the second position such that when the slip sheet is in the first position the guide member is configured to guide the containers on the slip sheet as the containers are received thereon.

In the present description, certain terms have been used for brevity, clarity, and understanding. No unnecessary limitations are to be inferred therefrom beyond the requirement of the prior art because such terms are used for descriptive purposes only and are intended to be broadly construed. The different apparatuses, systems, and methods described herein may be used alone or in combination with other apparatuses, systems, and methods.

What is claimed is:

1. A system for loading containers onto a transport structure, the system comprising:
a slip sheet configured to receive the containers and having a first end and an opposite second end, wherein the slip sheet is moveable in a first direction from a first position in which the containers are received onto the slip sheet and a second position in which the slip sheet is vertically above the transport structure, and wherein the slip sheet is further movable in a second direction opposite the first direction;
a first brace member that is adjacent to the second end of the slip sheet when the slip sheet is in the second position;
a second brace member that is adjacent to the first end of the slip sheet when the slip sheet is in the second position; and
wherein when the slip sheet is moved in the second direction from the second position to the first position the second brace member is configured to prevent the containers from moving in the second direction with the slip sheet such that the containers vertically fall off the slip sheet onto the transport structure, and wherein the first brace member is configured to vertically guide the containers onto the transport structure.

2. The system according to claim 1, wherein the first brace member is configured to prevent rotation of the containers such that the containers vertically fall off the slip sheet.

3. The system according to claim 2, wherein first brace member is configured to pivot into contact with the containers before the slip sheet is moved in the second direction.

4. The system according to claim 3, wherein the first brace member is elongated along the second end of the slip sheet.

5. The system according to claim 1, wherein the second brace member is pivotable into and between a first position in which the second brace member is vertically above the containers on the slip sheet and a second position in which the second brace member is adjacent to the containers on the slip sheet; and
wherein when second brace member is in the first position the containers vertically pass under the second brace member as the slip sheet is moved in the first direction.

6. The system according to claim 5, wherein the second brace member has a guide arm configured to pivot into contact with the containers and thereby guide the containers onto the transport structure as the containers fall off of the slip sheet.

7. The system according to claim 6, wherein the second brace member and the guide arm are elongated along the first end of the slip sheet.

8. The system according to claim 7, wherein the guide arm has a first elongated member and a second elongated member that are parallel to each other, and wherein the first elongated member and the second elongated member are configured to guide the containers onto the transport structure.

9. The system according to claim 8, wherein the first elongated member and the second elongated member are configured to prevent rotation of the containers such that the containers vertically fall off the slip sheet.

10. The system according to claim 1, further comprising a guide member configured to guide the containers on the slip sheet as the containers are received onto the slip sheet.

11. The system according to claim 10, wherein before the slip sheet is moved in the first direction from the first position to the second position the guide member is vertically moved away from the slip sheet such that the containers freely move under the guide member when the slip sheet is moved in the first direction.

12. The system according to claim 11, wherein the guide member is an elongated rod along which the containers slide.

13. A method of loading containers onto a transport structure, method comprising:
receiving containers onto a slip sheet having a first end and an opposite second end;
moving the slip sheet with the containers thereon in a first direction from a first position in which the containers are loaded onto the slip sheet to a second position in which the slip sheet is vertically above the transport structure, wherein a first brace member is adjacent to the second end of the slip sheet when the slip sheet is in the second position;
moving a second brace member adjacent to the first end of the slip sheet when the slip sheet is in the second position; and
moving the slip sheet in a second direction opposite the first direction from the second position to the first position such that the second brace member prevents the containers from being moved with the slip sheet in the second direction and the containers fall off the slip sheet onto the transport structure, and wherein the first brace member vertically guides the containers onto the transport structure.

14. The method according to claim 13, wherein the first brace member is configured to prevent rotation of the containers such that the containers vertically fall off the slip sheet.

15. The method according to claim 14, further comprising pivoting the first brace member into contact with the containers before the slip sheet is moved in the second direction from the second position to the first position.

16. The method according to claim 13, wherein the second brace member is movable into and between a first position in which the second brace member is vertically above the containers on the slip sheet and a second position in which the second brace member is adjacent to the first end of the slip sheet and the containers when the slip sheet is in the second position.

17. The method according to claim 13, further comprising pivoting a guide arm of the second brace member into contact with the containers to thereby vertically guide the containers onto the transport structure as the slip sheet is moved in the second direction.

18. The method according to claim 17, wherein the guide arm has a first elongated member and a second elongated member that extend parallel to each other, and wherein the first elongated member and the second elongated member are configured to contact the containers and vertically guide the containers onto the transport structure as the slip sheet is moved in the second direction.

19. The method according to claim 18, wherein the first elongated member and the second elongated member are configured to prevent rotation of the containers such that the containers vertically fall off the slip sheet.

20. The method accordingly to claim 13, further comprising moving a guide member vertically away from the slip sheet before the slip sheet and the containers are moved in the first direction the first position to the second position, wherein when the slip sheet is in the first position the guide member is configured to guide the containers on the slip sheet as the containers are received thereon.
